(19) United States
(12) Patent Application Publication
(10) Pub. No.: US 2025/0044235 A1
(43) Pub. Date: Feb. 6, 2025

(54) OPTICAL APPARATUS, OPTICAL INSPECTION APPARATUS, OPTICAL INSPECTION METHOD, AND NON-TRANSITORY STORAGE MEDIUM STORING OPTICAL INSPECTION PROGRAM

(71) Applicant: KABUSHIKI KAISHA TOSHIBA, Tokyo (JP)

(72) Inventors: Hiroshi OHNO, Tokyo (JP); Hideaki OKANO, Yokohama Kanagawa (JP); Hiroya KANO, Kawasaki Kanagawa (JP); Takahiro KAMIKAWA, Yokohama Kanagawa (JP); Kenta TAKANASHI, Kawasaki Kanagawa (JP)

(73) Assignee: KABUSHIKI KAISHA TOSHIBA, Tokyo (JP)

(21) Appl. No.: 18/588,811

(22) Filed: Feb. 27, 2024

(30) Foreign Application Priority Data
Jul. 31, 2023 (JP) 2023-124484
Aug. 22, 2023 (JP) 2023-134750

(51) Int. Cl. G01N 21/88

(52) U.S. Cl. CPC G01N 21/8806; G01N 21/8851; G01N 2021/8845

(57) ABSTRACT

According to the embodiment, an optical apparatus includes an illumination optical element having a focal plane or a focal plane region including a vicinity of the focal plane; and a projection portion including a light source. The projection portion is configured to emit a light flux including light of at least two different wavelength spectra from the light source to the illumination optical element. The projection portion is configured to form a projection image at different positions by light of the two different wavelength spectra in the focal plane or the focal plane region of the illumination optical element.

### CROSS-REFERENCE TO RELATED APPLICATIONS

This application is based upon and claims the benefit of priority from Japanese Patent Applications No. 2023-124484, filed Jul. 31, 2023; and No. 2023-134750, filed Aug. 22, 2023, the entire contents of all of which are incorporated herein by reference.

### FIELD

Embodiments described herein relate generally to an optical apparatus, an optical inspection apparatus, an optical inspection method, and a non-transitory storage medium storing optical inspection program.

### BACKGROUND

Contactless inspection of objects is important in various industries. In a conventional method, there is a method in which a color (wavelength spectrum) of a light beam dispersed using a diffraction grating or a wavelength filter is made to correspond to a light beam direction on a one-to-one basis, the direction of the light beam is identified by identifying the color, and information on an object face or in the object is acquired.

### BRIEF DESCRIPTION OF DRAWINGS

FIG. 1 is a schematic view illustrating an optical apparatus of an optical inspection apparatus according to a first embodiment.

FIG. 2 is a view of a projection image at a projection plane of the optical apparatus of the optical inspection apparatus illustrated in FIG. 1 as viewed from a projection portion side.

FIG. 3 is a view of a modification of a projection image at a projection plane of the optical apparatus of the optical inspection apparatus illustrated in FIG. 1 as viewed from a projection portion side.

FIG. 4 is a view of a modification of a projection image at a projection plane different from those in FIG. 3 of the optical apparatus as viewed from a projection portion side.

FIG. 5 is a view of a modification of a projection image at a projection plane different from those in FIGS. 3 and 4 of the optical apparatus as viewed from a projection portion side.

FIG. 6 is a schematic view illustrating a modification of the optical apparatus of the optical inspection apparatus according to the first embodiment.

FIG. 7 is a schematic view illustrating an optical inspection apparatus according to a second embodiment.

FIG. 8 is a flowchart of optical inspection processing of an object surface of the optical inspection apparatus according to the second embodiment.

FIG. 9 is a schematic view illustrating an imaging side from an object face of an optical apparatus of an optical inspection apparatus according to a modification of the second embodiment.

FIG. 10 is a schematic view illustrating an optical apparatus of an optical inspection apparatus according to a third embodiment.

FIG. 11 is a schematic view of a projection image on a projection plane from a projection portion toward an illumination lens of an optical apparatus according to a first modification of the third embodiment.

FIG. 12 is a schematic view of a projection image on a projection plane from a projection portion toward an illumination lens of an optical apparatus according to a second modification of the third embodiment.

FIG. 13 is a schematic view illustrating an optical apparatus of an optical inspection apparatus according to a fourth embodiment.

FIG. 14 is a schematic view illustrating an optical apparatus of an optical inspection apparatus according to a first modification of the fourth embodiment.

FIG. 15 is a schematic perspective view illustrating an optical apparatus of an optical inspection apparatus according to a fifth embodiment.

### DETAILED DESCRIPTION

A problem to be solved by the present embodiment is to provide an optical apparatus, an optical inspection apparatus, an optical inspection method, and a non-transitory storage medium storing optical inspection program capable of associating a light beam direction (light flux direction) with a wavelength spectrum.

According to the embodiment, an optical apparatus includes an illumination optical element having a focal plane or a focal plane region including a vicinity of the focal plane; and a projection portion including a light source. The projection portion is configured to emit a light flux including light of at least two different wavelength spectra from the light source to the illumination optical element. The projection portion is configured to form a projection image at different positions by light of the two different wavelength spectra in the focal plane or the focal plane region of the illumination optical element.

Hereinafter, each embodiment will be described with reference to the drawings. The drawings are schematic or conceptual, and a relationship between a thickness and a width of each portion, a ratio of sizes between portions, and the like are not necessarily the same as actual ones. In addition, even in the case of representing the same portion, dimensions and ratios may be represented differently from each other depending on the drawings. In the present specification and each drawing, elements similar to those described above with respect to the previously described drawings are denoted by the same reference numerals, and the detailed description thereof is appropriately omitted.

### First Embodiment

Hereinafter, an optical inspection apparatus 10 according to the present embodiment will be described in detail with reference to the drawings.

In the present specification, light is a type of electromagnetic wave, and includes gamma rays, X-rays, ultraviolet rays, visible light, infrared rays, radio waves, and the like. In the present embodiment, light is visible light, and for example, the wavelength is in a region of 400 nm to 750 nm.

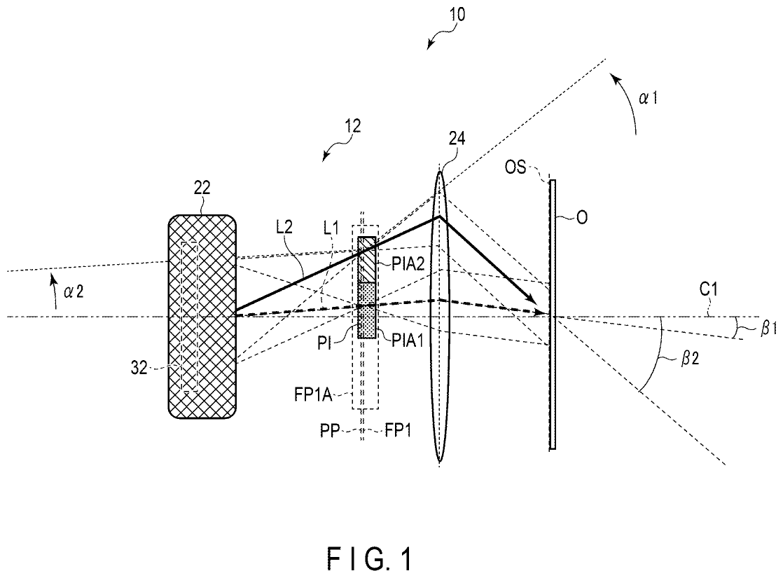

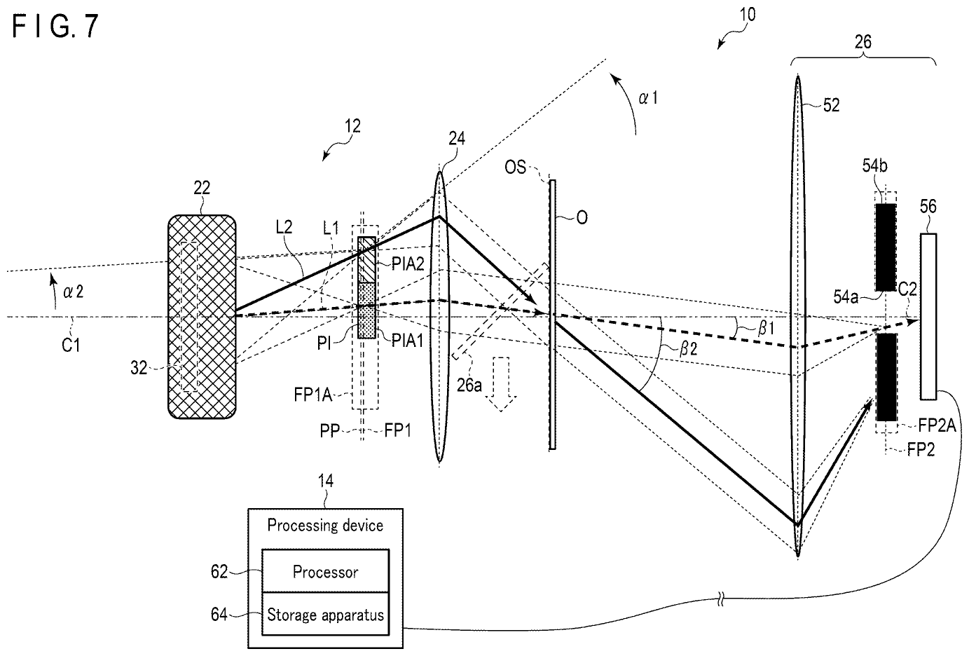

FIG. 1 is a schematic cross-sectional view of an optical apparatus 12 of an optical inspection apparatus 10 according to the present embodiment and a virtual projection image PI at a projection plane PP formed by the optical apparatus 12. In the present specification, black-and-white projection and color projection are described as projection. In the optical apparatus 12 according to the present embodiment in FIG. 1, illustration of an imaging portion 26 (see FIG. 7 of a second embodiment) is omitted. Thus, the optical apparatus 12 here will be mainly described as an optical apparatus that can be used as an illumination apparatus that irradiates a surface OS of an object with light of a desired color obliquely from an appropriate angle or perpendicularly.

The optical apparatus 12 according to the present embodiment includes a projection portion 22 and an illumination optical element 24.

The projection portion 22 includes a light source 32, and is configured to emit light of at least two different wavelength spectra in the same period. These wavelength spectra are referred to as a first wavelength spectrum and a second wavelength spectrum. For example, the first wavelength spectrum is blue light having a peak at a wavelength of 450 nm and a full width at half maximum of 100 nm. Further, the second wavelength spectrum is, for example, red light having a peak at a wavelength of 650 nm and a full width at half maximum of 100 nm. However, it is not limited thereto, and the wavelength spectrum emitted from the light source 32 may be any wavelength spectrum.

The projection portion 22 is configured to form various images by imaging light fluxes emitted from the light source 32 in the same period on a projection plane PP. Here, imaging means that a light flux from a certain point is collected at another point. A point of an imaging source is referred to as an object point, and a point of an imaging destination is referred to as an image point. Formation of an image by a set of image points by such image formation is referred to as projection. A first light beam L1 having the first wavelength spectrum is projected from the projection portion 22 onto the projection plane PP, and a second light beam L2 having the second wavelength spectrum is projected onto another point on the projection plane PP. The image projected by the projection portion 22 is referred to as a projection image PI.

The illumination optical element 24 is configured to image light. The illumination optical element 24 may be, for example, a single lens, a set lens including a plurality of lenses, a concave mirror, a diffraction grating, a gradient index lens (GRIN lens), or the like. That is, the illumination optical element 24 may be any element as long as light can be imaged. A surface on which a set of points at infinity is imaged by the illumination optical element 24 is defined as an illumination focal plane FP1. However, the illumination focal plane FP1 may be simply referred to as a focal plane. The illumination focal plane FP1 and the vicinity thereof are referred to as an illumination focal plane region FP1A or simply as a focal plane region. An optical axis C1 of the illumination optical element 24 is a straight line orthogonal to the focal plane FP1, and light emitted from a point on the straight line is imaged on the straight line again. The illumination optical element 24 of the present embodiment is, for example, a Fresnel lens. The Fresnel lens 24 can achieve a lens having a large effective diameter even if a focal length is short as compared with other lenses. Thus, the incident angle of the light beam reaching the Fresnel lens 24 from the illumination focal plane FP1 can be increased. Thus, if the Fresnel lens is used as the illumination optical element 24, there is an effect that the incident angle on the object face OS can be increased. However, the illumination optical element 24 is not limited thereto, and various optical elements that image light can be used.

An object O may transmit or reflect light. Alternatively, the object O may be translucent. A point on a surface of the object O or inside the object is referred to as an object point. Hereinafter, unless otherwise specified, it is assumed that the object O reflects light, and the object point is on the surface of the object O. The surface of the object O may be referred to as an object face or an object face. However, strictly speaking, an object surface is a surface belonging to an object, whereas an object face means a face illuminated by illumination. Hereinafter, the object surface or the object face is denoted by a reference sign OS.

The light flux emitted from the projection portion 22 passes through the illumination focal plane region FP1A of the illumination optical element 24 and passes through the illumination optical element 24, and the object face OS is irradiated with the light flux. A divergence angle of the light flux is a maximum divergence angle with respect to the optical axis C1 of the light beam included in the light flux. A divergence angle of the light flux immediately after passing through the illumination focal plane FP1 is defined as a first divergence angle α1, and a divergence angle of the light flux immediately before entering the illumination focal plane FP1 is defined as a second divergence angle α2. However, there is also a case where the light flux from the projection portion 22 is a light flux (condensing flux) to be condensed. In this case, the second divergence angle α2 is set to 0.

The projection portion 22 is configured to change the light emitted from the light source 32 in the same period and instantaneously change (vary) the projection image PI. For example, the projection portion 22 can use a color projector. There are various types of projectors, and for example, a digital lighting processing (DLP) or a liquid crystal optical element is used, and an apparatus that projects an image at a magnification, a reduction, and an equal magnification is used. These projectors as the projection portion 22 can electrically switch the projection image instantaneously. Alternatively, the projection portion 22 may be a slide projector that projects a slide, an overhead projector (OHP) that projects an image written on a transparent sheet, or the like. However, it is assumed that these projection portions 22 can mechanically switch the projection image instantaneously. In the present embodiment, the projection portion 22 uses DLP, for example. However, the projection portion 22 is not limited thereto, and various projection portions can be used.

Next, an operation of the optical apparatus 12 of the optical inspection apparatus 10 according to the present embodiment will be described.

The light flux emitted from the projection portion 22 forms the projection image PI on the projection plane PP. However, the projection image PI is formed in the atmospheric environment. In order to emphasize this situation, the projection image PI on the projection plane PP is also referred to as a virtual projection image. A position of the projection plane PP determined by the projection portion 22 is a focal plane region FP1A of the illumination optical element 24. That is, the projection plane PP is arranged in the focal plane region FP1A. Therefore, the projection portion 22 images the light flux from the light source 32 on the focal plane FP1 or the focal plane region FP1A.

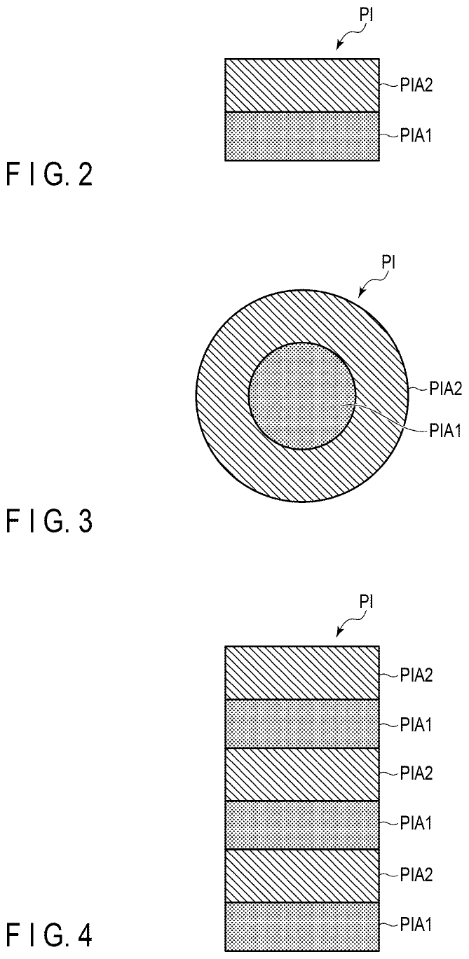

The virtual projection image PI includes a first virtual region PIA1 and a second virtual region PIA2. The first virtual region PIA1 is formed by imaging a light flux in which the first light beam L1 having the first wavelength spectrum is a main light beam on the projection plane PP. Further, the second virtual region PIA2 is formed by imaging a light flux in which the second light beam L2 having the second wavelength spectrum is a main light beam on the projection plane PP. The first virtual region PIA1 is formed so as to cross the optical axis C1 on the projection plane PP. The second virtual region PIA2 is formed so as not to cross the optical axis C1 on the projection plane PP. However, the virtual projection image PI is not limited thereto, and may be any image as long as the first virtual region PIA1 and the second virtual region PIA2 can be optically divided on the projection plane PP. The virtual projection image PI is preferably formed by partitioning appropriate areas PIA1 and PIA2 on the projection plane PP with light of a wavelength that can be dispersed by the imaging portion 26, such as RGB. The first virtual region PIA1 and the second virtual region PIA2 of the virtual projection image PI projected by the projection portion 22 can be formed as illustrated in FIG. 2 when the illumination optical element 24 side is viewed from the projection portion 22 side. That is, on the projection plane PP, the first virtual region PIAL and the second virtual region PIA2 of the virtual projection image PI are adjacent to each other in a rectangular shape. However, it is not limited thereto, and the virtual projection image may be any image. An instantaneous change of the virtual projection image PI by the projection portion 22 also includes changing the scales of the first virtual region PIA1 and the second virtual region PIA2 of such a virtual projection image PI.

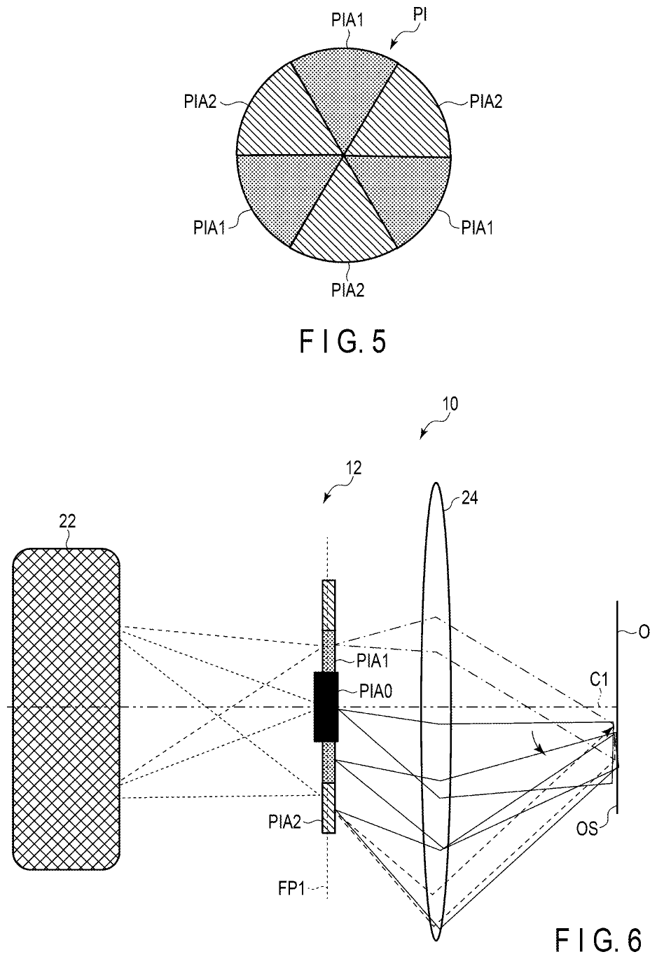

The first virtual region PIA1 and the second virtual region PIA2 of the virtual projection image PI projected by the projection portion 22 may be rotationally symmetric as illustrated in FIG. 3 with respect to the optical axis C1 of the illumination optical element 24, for example, when the illumination optical element 24 side is viewed from the projection portion 22 side, may be arranged in a stripe shape as illustrated in FIG. 4, or may be formed radially as illustrated in FIG. 5. That is, the virtual projection image PI may have any shape as long as at least the first virtual region PIA1 and the second virtual region PIA2 can be partitioned. Further, the projection portion 22 is configured to change the virtual projection image PI illustrated in FIGS. 2 to 5 in time series, for example. The projection portion 22 can project, for example, a predetermined projection image PI in time series in order or at random at an appropriate frame rate of an imaging element 56 of the imaging portion 26. Thus, the number of projection images PI per unit time projected by the projection portion 22 onto the projection plane PP in time series can be appropriately set. In this way, the image that can be acquired by the imaging portion 26 changes according to the projection image PI onto the projection plane PP. That is, in the imaging portion 26, one or various types of images for inspecting the presence or absence of the defect of the object face OS can be obtained according to the projection image PI.

Note that, in the example illustrated in FIG. 3, the optical axis C1 of the illumination optical element 24 intersects the first virtual region PIA1, and in the examples illustrated in FIGS. 4 and 5, the optical axis C1 of the illumination optical element 24 intersects any one of, for example, three first virtual regions PIA1 and three second virtual regions PIA2.

In the present embodiment, the virtual projection image PI illustrated in FIGS. 1 and 2 is projected on the projection plane PP.

The divergence angle of the light flux immediately after passing through the focal plane region FP1A becomes larger than that of the light flux immediately before the focal plane region FP1A. This is because the projection portion 22 forms the projection image PI in the focal plane region FP1A. That is, the projection portion 22 can make the divergence angle immediately after the light flux from the light source 32 passes through the focal plane FP1 or the focal plane region FP1A larger than the divergence angle immediately before the light flux passes through the focal plane FP1 or the focal plane region FP1A. Thus, the first divergence angle α1 is larger than the second divergence angle α2. Accordingly, the light flux reaching the illumination optical element 24 can reach not a local region of the illumination optical element 24 but a wider region. Thus, in a case where the optical apparatus 12 according to the present embodiment is used, there is an effect that an irradiation field in irradiation from the illumination optical element 24 to the object face OS is wide.

The illumination optical element 24 irradiates the object face OS with light incident through any point of the illumination focal plane FP1. Here, based on geometric optics (see H. Ohno, “One-shot three-dimensional measurement method with the color mapping of light direction,” OSA Continuum, Vol. 4, Issue 3, 2021), an angle of a light beam passing through the illumination optical element 24 with respect to the optical axis C1 of the illumination optical element 24 is determined according to a passing point on the illumination focal plane FP1. That is, all the light beams emitted from the same passing point of the projection plane PP or the illumination focal plane FP1 have the same light beam angle by the illumination optical element 24. Accordingly, when a light flux in which the first light beam L1 is a main light beam is imaged on the projection plane PP, all the light beams included in the light flux become parallel light fluxes having the same light beam angle by the illumination optical element 24, and the object face OS is irradiated with the parallel light fluxes. Thus, the angle of the first light beam L1 with respect to the optical axis C1 becomes a first light beam angle β1, and the first light beam L1 is incident on the object face OS. Similarly, when a light flux in which the second light beam L2 is a main light beam is imaged on the projection plane PP, all the light beams included in the light flux become parallel light fluxes having the same light beam angle by the illumination optical element 24, and the object face OS is irradiated with the parallel light fluxes. Thus, the angle of the second light beam L2 with respect to the optical axis C1 becomes a second light beam angle β2 and is incident on the object face OS.

The first divergence angle α1 is larger than the second divergence angle α2. On the other hand, in a case where the first divergence angle α1 is gradually decreased while the projection image PI is changed, and the outer edge of the second virtual region PIA2 away from the optical axis C1 is brought close to the optical axis C1, the number of points where the type of the light beam angle incident on the point decreases among the points on the irradiation field in irradiation from the illumination optical element 24 to the object face OS increases. In other words, by making the first divergence angle α1 larger than the second divergence angle α2, there is an effect that the type of the light beam angle incident on the point on the irradiation field in irradiation from the illumination optical element 24 to the object face OS can be increased.

Further, the light of the first wavelength spectrum and the light of the second wavelength spectrum have different colors. Thus, the optical apparatus 12 can irradiate the object face OS with a pencil of light beams having different light beam angles for respective colors. That is, the optical apparatus 12 can irradiate the object face OS with light beams having different incident angles for respective colors.

A direction distribution of the reflected light from the surface OS of the object changes according to a surface property and a surface shape of the surface OS of the object. The direction distribution of the reflected light is described by a bidirectional reflectance distribution function (BRDF). In general, the surface property and the surface shape of the surface OS of the object, that is, the object face information can be estimated by the BRDF. This BRDF greatly affects an image captured by the imaging portion 26 (see FIG. 7). That is, conversely, the image captured by the imaging portion 26 has information related to the BRDF.

The BRDF of the surface OS of the object varies depending on the incident angle of the incident light beam. That is, the information amount of the two BRDFs for two incident angles is larger than that of the BRDF for one incident angle. As the information related to the BRDF increases, the state of the surface OS of the object can be estimated in detail. The projection portion 22 of the optical apparatus 12 according to the present embodiment can variously change the virtual projection image PI, thereby instantaneously changing the incident angle with respect to the surface OS of the object. Then, there is an effect that a more detailed surface state of the object can be acquired by observing the reflected light by the imaging portion 26, for example, each time.

Furthermore, for example, in a case where the imaging portion 26 projects the projection images PI of different colors to the virtual regions PIA1 and PIA2 by appropriately dividing the projection images PI into the projection plane PP, and light beams of different incident angles for respective colors are incident on the surface OS of the object, reflected light corresponding to each of the incident angles can be distinguished by color and simultaneously acquired. That is, the optical apparatus 12 according to the present embodiment can make the light beams of at least two different wavelength spectra into light beams of different incident angles. Thus, for example, there is an effect that the imaging portion 26 can distinguish the reflected light corresponding to each of the incident angles by color and simultaneously acquire the reflected light. Accordingly, for example, there is an effect that the imaging portion 26 can acquire more detailed BRDF information of the surface OS of the object. This contributes in particular to an increase in both inspection speed and accuracy of the surface OS of the object in optical inspection.

According to the present embodiment, in an image captured by the imaging element 56 of the imaging portion 26 to be described later, it is assumed that a color of light (blue light) by the first light beam angle β1 is mainly in a portion that is a plane in the object face OS. On the other hand, in the image captured by the imaging element 56 of the imaging portion 26, a color of a defect portion of the object face OS changes depending on an inclination angle of the defect, but a color of light (red light) by the second light beam angle β2 may be mainly used, or the color of the light by the first light beam angle β1 and the color of the light by the second light beam angle β2 may be mixed. For example, as the inclination angle of the defect is smaller, an image is acquired as a color of the optical axis C1 or a region close to the optical axis C1 in the virtual projection image PI projected on the focal plane FP1 of the illumination optical element 24. Then, as the inclination angle is larger, an image is acquired as a color of a region far from the optical axis C1 in the virtual projection image PI projected on the focal plane FP1 of the illumination optical element 24.

In particular, in the optical inspection, it is necessary to select an optimum direction of the light beam with which the surface OS of the object is irradiated according to various types of the object O. Thus, conventionally, for example, it is necessary to prepare various types of ring illumination (oblique incident illumination). However, in a case where the optical apparatus (illumination apparatus) 12 according to the present embodiment is used, there is an effect that the incident angle of the light beam can be changed by instantaneously changing the virtual projection image PI. That is, by using one optical apparatus 12 according to the present embodiment, it is possible to selectively use various kinds of illumination apparatuses in various sizes with one apparatus.

Various projection portions 22 can be applied to the optical apparatus 12 according to the present embodiment. Thus, there is an effect that the optical apparatus 12 can widely select the commercially available projection portion 22 that can form the virtual projection image PI in the predetermined region FP1A (including the projection plane PP and the illumination focal plane FP1). Further, in the optical apparatus 12, there is an effect that a commercially available projection portion 22 can be used without being modified.

The optical apparatus 12 according to the present embodiment includes the illumination optical element 24 having the focal plane region FP1A including the focal plane FP1 or the vicinity thereof, and the projection portion 22 including the light source 32. Then, the projection portion 22 can emit light fluxes including light of at least two different wavelength spectra from the light source 32 to the illumination optical element 24. Further, the projection portion 22 projects light of two different wavelength spectra at different positions on the focal plane FP1 or the focal plane region FP1A of the illumination optical element 24 to form the projection image PI. Accordingly, the optical apparatus 12 of the optical inspection apparatus 10 according to the present embodiment can associate the direction of the light beam (the direction of the light flux) with the wavelength spectrum. The wavelength spectrum can be considered synonymous with a color of the light beam. Thus, it can be said that the direction of the light beam and the color of the light beam can be associated with each other by the optical apparatus 12.

Further, the projection portion 22 of the optical apparatus 12 of the optical inspection apparatus 10 according to the present embodiment can instantaneously change the virtual projection image PI. Thus, there is an effect that the optical apparatus 12 according to the present embodiment can instantaneously change the association between the direction of the light beam and a color of the light beam according to various uses.

### Modification

A modification of the first embodiment will be described with reference to FIG. 6.

FIG. 6 is a schematic cross-sectional view of an optical apparatus 12 of an optical inspection apparatus 10 and a virtual projection image PI formed by the optical apparatus 12 in the modification of the present embodiment. The virtual projection image PI illustrated in FIG. 6 is orthogonal to the optical axis C1. In the present modification, a first wavelength spectrum and a second wavelength spectrum are the same as those described in a third embodiment.

In the present modification, for example, a black light shielding region PIA0 is formed on the optical axis C1 of the illumination optical element 24 and in the illumination focal plane FP1 and the vicinity thereof. The light shielding region PIA0 may actually exist or may be virtual. In the case of the virtual one, it is preferable that the light shielding region PIA0 is not irradiated with light from the light source 32. In a case where the light shielding region PIA0 is virtual, the size and shape of the light shielding region PIA0 can be electrically changed.

Next, an operation of the optical apparatus 12 of the optical inspection apparatus 10 according to the present modification will be described.

The light flux emitted from the projection portion 22 forms the virtual projection image PI on the projection plane PP.

The virtual projection image PI includes the 0-th virtual region (light shielding region) PIA0, the first virtual region PIA1, and the second virtual region PIA2.

The 0-th virtual region (light shielding region) PIA0 is formed so as to cross the optical axis C1 of the illumination optical element 24 on the projection plane PP.

The first virtual region PIA1 is formed by imaging a light flux in which the first light beam L1 having the first wavelength spectrum is a main light beam on the projection plane PP. The first virtual region PIA1 is formed so as not to cross the optical axis C1 on the projection plane PP. Further, the second virtual region PIA2 is formed by imaging a light flux in which the second light beam L2 having the second wavelength spectrum is a main light beam on the projection plane PP. The second virtual region PIA2 is formed so as not to cross the optical axis C1 on the projection plane PP.

When the light flux in which the first light beam L1 is a main light beam is imaged on the projection plane PP, all the light beams included in the light flux become parallel light fluxes having the same light beam angle by the illumination optical element 24 according to the position of the projection plane PP, and the object face OS is irradiated with the parallel light fluxes. Thus, the angle of the first light beam L1 with respect to the optical axis C1 becomes the first light beam angle β1, and the first light beam L1 is incident on the object face OS. Similarly, when the light flux in which the second light beam L2 is a main light beam is imaged on the projection plane PP, all the light beams included in the light flux become parallel light fluxes having the same light beam angle by the illumination optical element 24 according to the position of the projection plane PP, and the object face OS is irradiated with the parallel light fluxes. Thus, the angle of the second light beam L2 with respect to the optical axis C1 becomes the second light beam angle β2 and is incident on the object face OS.

At this time, only the light flux in which the first light beam L1 is a main light beam and the light flux in which the second light beam L2 is a main light beam can be incident on the object face OS. That is, only the obliquely incident component can be incident on the object face OS. In other words, by forming the light shielding region PIA0 by the zero virtual region (light shielding region) PIA0, it is possible to achieve an oblique incident illumination by the light flux in which the first light beam L1 is a main light beam and the light flux in which the second light beam L2 is a main light beam. Thus, only components scattered by the object face OS can be imaged, and dark field imaging can be performed.

However, the virtual projection image PI is not limited thereto, and may be any image. The virtual projection image PI projected by the projection portion 22 may be, for example, rotationally symmetric with respect to the optical axis C1 of the illumination optical element 24, may be in a stripe shape, or may be radial. That is, the virtual projection image PI may have any shape.

From the above, the optical apparatus 12 of the optical inspection apparatus 10 according to the present modification can associate the direction of the light beam (the direction of the light flux) with the wavelength spectrum. Further, the virtual projection image PI can be instantaneously changed by the projection portion 22 of the optical apparatus 12. For example, in the projection plane PP, each of the regions PIA0, PIA1, and PIA2 can be expanded and contracted in an appropriate direction. Thus, there is an effect that the optical apparatus 12 according to the present modification can instantaneously change the association between a direction of a light beam and a color of the light beam according to various uses.

### Second Embodiment

FIG. 7 is a schematic cross-sectional view of an optical apparatus 12 of an optical inspection apparatus 10 according to a second embodiment and a virtual projection image PI formed by the optical apparatus 12. The optical inspection apparatus 10 according to the present embodiment includes an optical apparatus 12 and a processing device 14.

The optical apparatus 12 of the optical inspection apparatus 10 according to the present embodiment includes a projection portion 22, an illumination optical element 24, and an imaging portion 26. In the optical apparatus 12 of the optical inspection apparatus 10 according to the present embodiment, the projection portion 22 and the illumination optical element 24 have the same configurations as the projection portion 22 and the illumination optical element 24 of the optical apparatus 12 described in the first embodiment. Thus, the description of the projection portion 22 and the illumination optical element 24 of the optical apparatus 12 will be appropriately omitted.

The projection portion 22 is configured to instantaneously change (vary) the virtual projection image PI. The object O is opaque and reflects light at the surface. However, it is not limited thereto, and the object may be transparent or translucent. The surface of the object is defined as an object face OS.

In FIG. 7, an illumination system for illuminating the object face OS by the projection portion 22 is drawn on the left side of the object face OS, and an imaging system for imaging using light reflected from the object surface OS by the imaging portion 26 is simultaneously drawn on the right side of the object face OS. That is, the optical apparatus 12 in FIG. 7 draws the illumination side (illumination system) and the imaging side (imaging system) simultaneously on the left and right with the object face OS as a boundary. However, in practice, light reflected by the object face OS returns toward the projection portion 22. Thus, it is necessary to arrange a beam splitter 26a indicated by a broken line between the illumination optical element 24 and the object face OS and to guide the light reflected by the object face OS to the imaging portion 26 indicated by a broken line in FIG. 7. That is, in FIG. 7, the imaging portion 26 indicated by the broken line is schematically drawn on the right side of the object face OS. Note that the object O in FIG. 7 also originally has an appropriate thickness, but is drawn by ignoring the thickness.

A first wavelength spectrum emitted from the light source 32 of the projection portion 22 is blue light having a wavelength of 450 nm as a peak and a full width at half maximum of 100 nm. That is, a first wavelength is a wavelength included in the first wavelength spectrum, and is a peak of the first wavelength spectrum. Further, a second wavelength spectrum emitted from the light source 32 is red light having a peak at a wavelength of 650 nm and a full width at half maximum of 200 nm. That is, a second wavelength is a wavelength included in the second wavelength spectrum, and is a peak of the second wavelength spectrum. However, the first wavelength and the second wavelength may be different from each other, and may be any wavelengths as long as they are included in the first wavelength spectrum and the second wavelength spectrum, respectively. Further, the wavelength spectrum generated from the light source 32 is not limited thereto, and may be any wavelength spectrum. Here, it is assumed that the full width at half maximum of the second wavelength spectrum is 200 nm and overlaps with the first wavelength spectrum. As described above, the first wavelength spectrum and the second wavelength spectrum may overlap each other. Note that, as described in the first embodiment, assuming that the full width at half maximum of the second wavelength spectrum is 100 nm, the region overlapping the first wavelength spectrum is reduced. Thus, the first wavelength spectrum and the second wavelength spectrum may have an overlapping portion or may not have an overlapping portion.

The imaging portion 26 includes an imaging optical element 52, an imaging opening 54, and an imaging element (image sensor) 56.

The imaging optical element 52 can form an image of light. The imaging optical element 52 may be, for example, a single lens, a set lens including a plurality of lenses, a concave mirror, a diffraction grating, a gradient index lens (GRIN lens), or the like. That is, the imaging optical element 52 may be any element as long as light can be imaged. A plane on which a set of points at infinity is imaged by the imaging optical element 52 is defined as an imaging focal plane FP2. However, the imaging focal plane FP2 may be simply referred to as a focal plane. The imaging focal plane FP2 and the vicinity thereof are referred to as an imaging focal plane region FP2A or simply as a focal plane region. An optical axis C2 of the imaging optical element 52 is a straight line orthogonal to the imaging focal plane FP2, and light emitted from a point on the straight line is imaged on the straight line again. The imaging optical element 52 of the present embodiment is a set lens. However, the imaging optical element 52 is not limited thereto, and various optical elements that image light can be used.

The imaging opening 54 is disposed in the focal plane region FP2A of the imaging optical element 52. The imaging opening 54 has, for example, a ring shape, and a through hole 54a is provided in the vicinity of the optical axis C2 of the imaging opening 54 to allow light having a first wavelength and light having a second wavelength to pass therethrough. Meanwhile, a medium (light shielding body) 54b that shields light of a first wavelength and a second wavelength is provided around the through hole 54a of the imaging opening 54. At this time, based on the geometric optics, the imaging portion 26 has telecentricity on the object side with respect to the first wavelength and the second wavelength. That is, the imaging portion 26 of the optical apparatus 12 of the optical inspection apparatus 10 has object side telecentricity with respect to light having at least one wavelength in the light from the light source 32.

The imaging element 56 has pixels configured to disperse at least the first wavelength and the second light and each configured to independently acquire a light reception signal. Thus, it is assumed that the imaging portion 26 is configured to disperse at least two different wavelengths included in at least two different wavelength spectra of the light from the light source 32. The imaging element 56 may be an area sensor or a line sensor. In addition, the imaging element 56 may be a single pixel. That is, the imaging element 56 may be anything as long as it is configured to disperse at least two wavelengths and convert light into a light reception signal. In addition, the light reception signal of the imaging element 56 may be simply referred to as a signal, a signal value, or a pixel value.

Note that the processing device 14 is connected to the imaging element 56 of the imaging portion 26 in a wired or wireless manner. The processing device 14 preferably controls not only the imaging element 56 of the imaging portion 26 but also the light source 32 of the projection portion 22.

The processing device 14 includes a processor 62 configured to acquire an image captured by the imaging portion 26 and apply image processing to the acquired image, and a storage apparatus (non-transitory storage medium) 64 configured to store an image, for example.

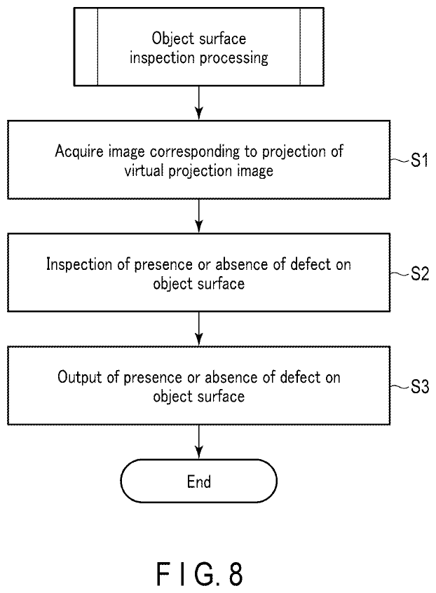

The processor 62 is, for example, a CPU or a GPU, but may be anything as long as it can perform calculation (inspection processing of the object surface OS illustrated in FIG. 8) to be described later. The processor 62 corresponds to a central part of a computer that performs processing such as calculation and control necessary for processing of the processing device 14, and integrally controls the entire processing device 14. The processor 62 executes control to implement various functions of the processing device 14 based on a program such as system software, application software, or firmware stored in the storage apparatus 64 such as a ROM or an auxiliary storage apparatus. The processor 62 includes, for example, a central processing unit (CPU), a micro processing unit (MPU), a digital signal processor (DSP), an application specific integrated circuit (ASIC), a field programmable gate array (FPGA), a graphics processing unit (GPU), or the like. Alternatively, the processor 62 is a combination of a plurality of these. The number of processors 62 provided in the processing device 14 may be one or plural.

The processing device 14 executes various functions by causing the processor 62 to execute a program or the like stored in the storage apparatus 64. Note that it is also preferable that a control program of the processing device 14 is not stored in the storage apparatus 64 of the processing device 14, and is placed on an appropriate server or cloud. In this case, the control program is executed while communicating with, for example, the processor 62 included in the optical inspection apparatus 10 via a communication interface. That is, the processing device 14 according to the present embodiment may be included in the optical inspection apparatus 10, or may be on a server or a cloud of a system of various inspection sites away from the optical inspection apparatus 10. Thus, it is also preferable that an optical inspection program is not stored in the storage apparatus 64 but is provided on a server or a cloud, and the program is executed while communicating with, for example, the processor 62 included in the optical inspection apparatus 10 via the communication interface. Therefore, the processor 62 (processing device 14) can execute an optical inspection program (optical inspection algorithm) to be described later.

The processor 62 (processing device 14) controls light emission timing of the light source 32 of the projection portion 22, acquisition timing of image data in the imaging element 56, acquisition of image data from the imaging element 56, and the like, and can perform appropriate image processing on a certain image.

Further, the storage apparatus 64 is, for example, an HDD or an SSD, but may be anything as long as it can store (store) an image, for example.

Next, an operation of the optical inspection apparatus 10 according to the present embodiment will be described.

It is assumed that a standard surface of the object surface OS is planar and smooth. At this time, light incident on the standard surface is specularly reflected. In specular reflection, based on the geometric optics, an incident angle and a reflection angle in an incident surface are equal, and the incident light beam and the reflected light beam can be associated with each other on a one-to-one basis. On the other hand, it is assumed that a defect such as unevenness, dirt, or a scratch exists on the object surface OS. Then, the light incident on the defect is scattered and reflected in various directions. That is, reflected light beams in various directions are generated for one incident light beam. A direction distribution of such reflected light beams can be described by the BRDF.

The processor 62 of the processing device 14 controls the light source 32 of the projection portion 22 and emits light in a predetermined direction from the light source 32 of the projection portion 22. The light flux emitted from the projection portion 22 forms the projection image PI on the projection plane PP.

As described above, the virtual projection image PI includes the first virtual region PIA1 and the second virtual region PIA2 adjacent to each other. The first virtual region PIA1 is formed by imaging a light flux in which a first light beam L1 having the first wavelength spectrum is a main light beam on the projection plane PP. Further, the second virtual region PIA2 is formed by imaging a light flux in which a second light beam L2 having the second wavelength spectrum is a main light beam on the projection plane PP. Then, when a light flux in which the first light beam L1 is a main light beam is imaged on the projection plane PP, all the light beams included in the light flux become parallel light fluxes having the same light beam angle by the illumination optical element 24, and the object face OS is irradiated with the parallel light fluxes. Thus, the angle of the first light beam L1 with respect to the optical axis C1 becomes a first light beam angle β1, and the first light beam L1 is incident on the object face OS. Similarly, when a light flux in which the second light beam L2 is a main light beam is imaged on the projection plane PP, all the light beams included in the light flux become parallel light fluxes having the same light beam angle by the illumination optical element 24, and the object face OS is irradiated with the parallel light fluxes. Thus, the angle of the second light beam L2 with respect to the optical axis C1 of the illumination optical element 24 becomes a second light beam angle β2, and the second light beam L2 is incident on the object face OS.

A first divergence angle α1 is larger than a second divergence angle α2. On the other hand, when the first divergence angle α1 is gradually decreased, the number of points at which the type of the light beam angle incident on the point decreases among the points on the irradiation field of the object face OS increases. In other words, by making the first divergence angle α1 larger than the second divergence angle α2, there is an effect that the type of the light beam angle incident on the point on the irradiation field in irradiation from the illumination optical element 24 to the object face os can be increased. Further, the light of the first wavelength spectrum and the light of the second wavelength spectrum have different colors. Thus, the optical apparatus 12 can irradiate the object face os with a pencil of light beams having different light beam angles for respective colors. That is, the optical apparatus 12 can irradiate the object face OS with light beams having different incident angles for respective colors.

From the above, the optical apparatus 12 of the optical inspection apparatus 10 according to the present embodiment can associate the direction of the light beam (the direction of the light flux) with the wavelength spectrum. Further, the virtual projection image PI can be instantaneously changed by the projection portion 22 of the optical apparatus 12. Thus, there is an effect that the optical apparatus 12 according to the present embodiment can instantaneously change the association between the direction of the light beam and a color of the light beam according to various uses.

The optical inspection apparatus 10 illuminates the object surface OS using the projection portion 22 of the optical apparatus 12, images the object surface OS using the imaging portion 26, and acquires the image of the object surface OS corresponding to the virtual projection image PI by the processor 62 of the processing device 14 (step S1 in FIG. 8).

First, a case where the object surface OS is the standard surface will be considered. In this case, as illustrated in FIG. 7, the first light beam L1 is specularly reflected by the object surface OS, passes through the imaging opening 54, and is imaged by the imaging element 56. Here, an angle formed by reflected light when the first light beam L1 is reflected with respect to the imaging optical axis C2 is defined as a first reflected light beam angle γ1. On the other hand, the second light beam L2 is specularly reflected by the object surface OS and shielded by the imaging opening 54. Here, an angle formed by reflected light when the second light beam L2 is reflected with respect to the imaging optical axis C2 is defined as a second reflected light beam angle γ2. Accordingly, the second light beam L2 is not captured by imaging portion 26. That is, in a case where the object surface OS is the standard surface, the imaging portion 26 performs imaging only at the first wavelength and does not perform imaging at the second wavelength. In other words, the standard surface of the object surface OS is imaged only with blue light and is not imaged with red light.

Next, a case where a defect exists on the object surface OS will be considered. In particular, it is assumed that there is a defect on the surface that the first light beam L1 and the second light beam L2 reach. Then, the first light beam L1 is scattered by the defect of the object surface OS, and the BRDF spreads. Thus, a part of the scattered light passes through the imaging optical element 52 and the imaging opening 54 and is imaged by the imaging element 56. On the other hand, the second light beam L2 is also scattered by the defect of the object surface OS, and the BRDF spreads. Thus, a part of the scattered light passes through the imaging optical element 52 and the imaging opening 54 and is imaged by the imaging element 56. That is, if there is a defect on the object surface OS, the defect is imaged with light of the first wavelength and light of the second wavelength. In other words, defects in the object surface OS are imaged with both blue light and red light.

As described above, (the processor 62 of) the processing device 14 can determine the presence or absence of a defect on the object surface OS by a color of a captured image acquired by the imaging element 56 of the imaging portion 26. That is, as illustrated in FIG. 8, the processing device 14 inspects the presence or absence of a defect on the object surface OS based on an image acquired by the imaging portion 26 (step S2).

Then, as illustrated in FIG. 8, in the example of the present embodiment, when it is determined that light of one color (blue light) is incident based on the light reception signals of all the pixels of the imaging element 56, the processing device 14 can output that there is no defect on the surface OS of the object to be a subject. Further, when it is determined that two colors (blue light and red light) are incident on the light reception signals of some pixels based on the light reception signals of all the pixels of the imaging element 56, the processing device 14 can output that there is a defect on the surface OS of the object to be a subject. In this manner, the processing device 14 can output whether or not there is a defect on the surface OS of the object to be a subject (step S3). Therefore, when performing the optical inspection, the processing device 14 (processor 62) can output the state of the object surface OS based on the number of colors emitted from the light source 32 and the number of colors acquired in respective pixels of the imaging element 56 of the imaging portion 26.

The optical inspection apparatus 10 can perform such inspection processing of the object surface OS illustrated in FIG. 8 by the processing device 14 every time the virtual projection image PI projected on the projection plane PP is changed. Thus, for example, the optical inspection apparatus 10 can perform the optical inspection of the object surface OS based on information of colors of an image captured by the imaging portion 26 every time the processor 62 of the processing device 14 projects a plurality of different virtual projection images PI onto the projection plane PP, and can output the presence or absence of the defect. The processing device 14 can perform the optical inspection of the object surface OS by various illumination methods at an appropriate speed by performing synchronization so as to cause the imaging element 56 to capture an image when the projection portion 22 electrically or mechanically switches to project a different virtual projection image PI onto the projection plane PP. In a case where the different virtual projection image PI is electrically or mechanically switched to be projected on the projection plane PP by the general projection portion 22, for example, if there is performance of approximately 60 fps or more, the projection portion 22 can project 60 images or more in one second. Further, by acquiring the image in synchronization with the imaging element 56, the optical inspection of the object surface OS can be performed using light from various different directions and light of various colors in a relatively short time. Thus, the optical inspection apparatus 10 according to the present embodiment can improve optical inspection accuracy as compared with a case where the optical inspection of the object surface OS is performed using one type of conventional illumination apparatus.

Note that, in a case where the imaging portion 26 does not have the imaging opening 54, that is, in a case where the imaging opening 54 does not exist on the focal plane FP2 of the imaging optical element 52 between the imaging optical element 52 and the imaging element 56, the presence or absence of a defect on the object surface O cannot be identified by color as described above. This is because in a case where the imaging opening 54 is not provided, light of all colors emitted from the light source 32 is imaged by the imaging element 56 regardless of the presence or absence of a defect on the object surface OS. For this reason, the imaging portion 26 of the optical inspection apparatus 10 has the object side telecentricity with respect to the light having at least one wavelength in the light from the light source 32, so that there is an effect that the presence or absence of the defect of the object surface OS can be identified.

Note that the processing device 14 of the optical inspection apparatus 10 described in the present embodiment can be used together with the optical apparatus 12 according to the third embodiment, the fourth embodiment, and the fifth embodiment to be described later.

### Modification

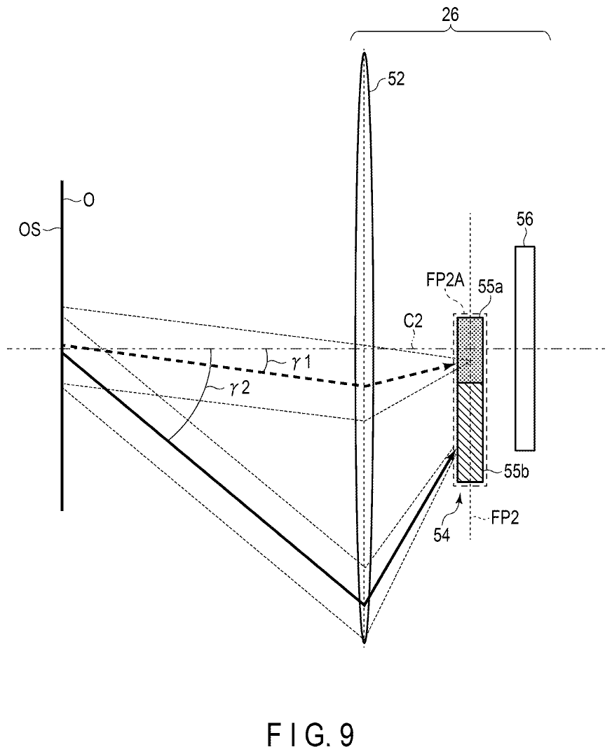

A modification of the imaging portion 26 of the optical apparatus 12 of the optical inspection apparatus 10 of the second embodiment will be described with reference to FIG. 9. In the present modification, the imaging portion 26 is the same as the imaging portion 26 of the optical apparatus 12 of the optical inspection apparatus 10 described in the second embodiment except for the imaging opening 54 of the imaging portion. That is, since the projection portion 22 and the illumination optical element 24 of the optical apparatus 12 have the same configurations as those described in the first embodiment and the second embodiment, the description thereof will be omitted here.

FIG. 9 is a schematic cross-sectional view of an imaging portion 26 side with respect to the object face OS in the optical apparatus 12 of the optical inspection apparatus 10 according to the present modification. The cross-sectional view illustrated in FIG. 9 includes imaging optical axis C2 of imaging portion 26.

The imaging opening 54 according to the present modification includes a first wavelength selection region 55a and a second wavelength selection region 55b. The imaging opening 54 according to the present modification is not a virtual one formed by projection, but is actually present. The first wavelength selection region 55a allows light of a first wavelength (for example, blue light) to pass therethrough. However, the first wavelength selection region 55a shields light of the second wavelength (for example, red light). The second wavelength selection region 55b allows light of a second wavelength to pass therethrough. However, the second wavelength selection region 55b shields light of the first wavelength. Note that the first wavelength selection region 55a is disposed so as to cross the optical axis C2 of the imaging portion 26 at the imaging focal plane FP2 of the imaging optical element 52. The second wavelength selection region 55b is disposed so as not to cross the optical axis C2 of the imaging portion 26 at the imaging focal plane FP2 of the imaging optical element 52.

An operation of the optical inspection apparatus 10 of the present modification will be described.

In the present modification, the virtual projection image PI by the projection portion 22 has the first virtual region PIA1 and the second virtual region PIA2 (see FIG. 7).

First, it is assumed that the first virtual region PIA1 is formed by imaging the light flux in which the first light beam L1 having the first wavelength spectrum is a main light beam on the projection plane PP. It is assumed that the second virtual region IA2 is formed by imaging the light flux in which the second light beam L2 having the second wavelength spectrum is a main light beam on the projection plane PP. At this time, the first light beam L1 passes through the first wavelength selection region 55a. The second light beam L2 passes through the second wavelength selection region 55b. That is, both the first light beam L1 and the second light beam L2 pass through the imaging opening 54, and are imaged by the imaging element 56. This does not depend on the presence or absence of a defect on the surface OS of the object. That is, the object surface OS is imaged at the first wavelength (for example, blue light) and the second wavelength (for example, red light) by the imaging element 56 regardless of the presence or absence of the defect. That is, the imaging element 56 of the optical apparatus 12 according to the present modification can acquire a normal color image. In other words, the imaging element 56 of the optical apparatus 12 according to the present modification can acquire a bright field image of the surface OS of the object that may include the defect.

Next, it is assumed that the first virtual region PIA1 is formed by imaging the light flux in which the second light beam L2 having the second wavelength spectrum is a main light beam on the projection plane PP. It is assumed that the second virtual region is formed by imaging the light flux in which the first light beam L1 having the first wavelength spectrum is a main light beam on the projection plane PP. In this case, blue light and red light are replaced with each other as compared with the above-described example. That is, the processing device 14 controls the light source 32, and replaces the emission of blue light and red light with the above-described example.

At this time, if the surface OS of the object is the standard surface, both the first light beam L1 and the second light beam L2 are shielded by the imaging opening 54. That is, light is not incident on the imaging element 56 and is not imaged by the imaging element 56 on the surface OS of the object which is the standard surface.

On the other hand, it is assumed that a defect exists on the surface OS of the object, and a defect exists in the arrival region of the first light beam L1 and the second light beam L2. At this time, both the first light beam L1 and the second light beam L2 are scattered, and each BRDF spreads. Thus, a part of each scattered light passes through the imaging opening 54. Accordingly, in the imaging element 56, the defect is imaged by the first light beam L1 and/or the second light beam L2. That is, the imaging element 56 of the optical apparatus 12 according to the present modification can acquire a dark field image in which the contrast of the defect is enhanced with respect to the standard surface.

As described above, with the optical apparatus 12 of the present modification, by the imaging opening 54 including at least two wavelength selection regions 55a and 55b, there is an effect that the projection image PI by the projection portion 22 is changed, and the imaging element 56 can acquire both the bright field image and the dark field image. Accordingly, the optical inspection apparatus 10 can acquire detailed information of the object surface OS.

Then, in the present modification, it is assumed that the processing device 14 can identify that the projection image PI projected by the projection portion 22 is different. That is, in the present modification, the processing device 14 can recognize the switching between the mode of acquiring the bright field image and the mode of acquiring the dark field image, and acquires an image for each mode (see step S1 in FIG. 8). In the mode of acquiring the dark field image, the processing device 14 can determine whether or not two colors (blue light and red light) are incident on light reception signals of some pixels based on the light reception signals of all the pixels of the imaging element 56 (see step S2 in FIG. 8). Then, the processing device 14 can output whether or not there is a defect on the surface OS of the object to be a subject (see step S3 in FIG. 8). In this manner, the optical inspection apparatus 10 can perform the inspection processing of the object surface OS illustrated in FIG. 8 using the processing device 14 and output whether or not there is a defect on the surface OS of the object to be a subject.

The imaging portion 26 according to the present modification can be used for the optical apparatus 12 according to the third embodiment and the fourth embodiment to be described later.

### Third Embodiment

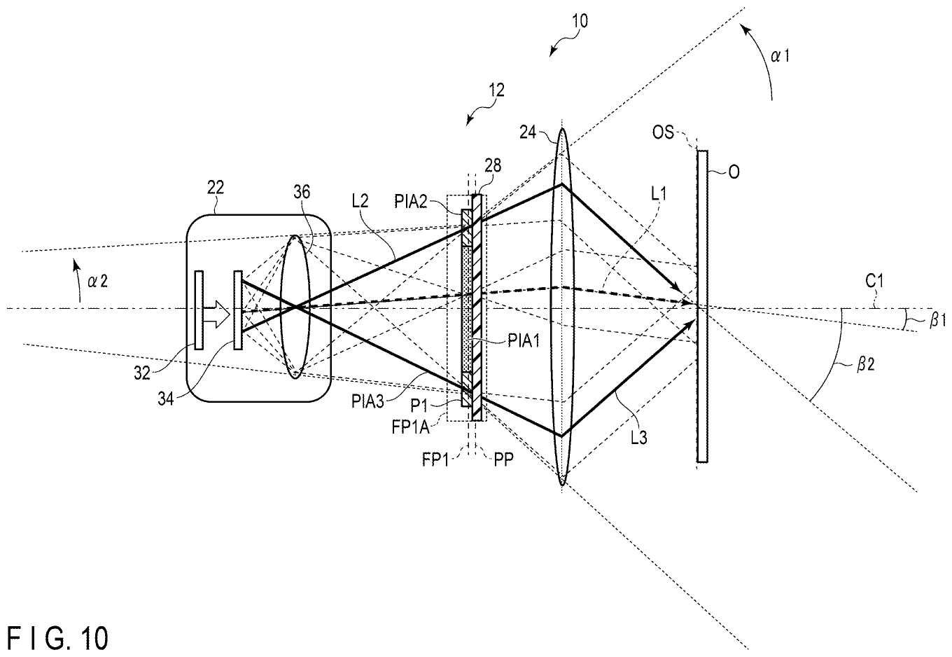

FIG. 10 is a schematic cross-sectional view of an optical apparatus 12 of an optical inspection apparatus 10 according to a third embodiment and a virtual projection image PI formed by the optical apparatus 12. The present embodiment is a modification of the optical inspection apparatus 10 described in the first embodiment including the modification and the second embodiment including the modification, and the same members or members having the same functions as the members described in the first embodiment including the modification and the second embodiment including the modification are denoted by the same reference numerals, and the description thereof will be omitted.

The optical apparatus 12 according to the present embodiment includes a projection portion 22, an illumination optical element 24, and a light diffusion plate (light diffusion portion) 28. Here, illustration of the imaging portion 26 described in the second embodiment (including modifications) is omitted.

The projection portion 22 is configured to instantaneously change (vary) the virtual projection image PI. In the present embodiment, the projection portion 22 uses, for example, liquid crystal. However, the projection portion 22 is not limited thereto, and DLP can also be used as described above.

The projection portion 22 includes, for example, two light sources 32 being configured to emit light of two different wavelength spectra. In FIG. 6, for convenience, the light source 32 is depicted as one. The light from the two light sources 32 can be multiplexed using a dichroic mirror or the like immediately before reaching the projection lens 36. These wavelength spectra are referred to as a first wavelength spectrum, a second wavelength spectrum, and a third wavelength spectrum, respectively. For example, the first wavelength spectrum is blue light having a peak at a wavelength of 450 nm and a full width at half maximum of 100 nm. Further, the second wavelength spectrum is red light having a peak at a wavelength of 650 nm and a full width at half maximum of 100 nm. The third wavelength spectrum is the same as the second wavelength spectrum. However, it is not limited thereto, and any wavelength spectrum may be used.

The projection portion 22 includes a spatial modulator 34 with liquid crystal, and a projection lens 36. The projection lens 36 images the light flux emitted from the light source 32 and passing through the spatial modulator 34 on the projection plane PP. The spatial modulator 34 has a plurality of pixels, and can form various images by independently modulating each of the pixels. In FIG. 10, the spatial modulator 34 is depicted as a spatial modulator for convenience. In practice, the light of different wavelength spectra from the two light sources 32 is spatially modulated independently by the two spatial modulators 34 through which the light passes, and is multiplexed using a dichroic mirror or the like. After the multiplexing, the multiplexed light is made incident on the projection lens 36. The projection portion 22 projects a first light beam L1 having the first wavelength spectrum, a second light beam L2 having the second wavelength spectrum, and a third light beam L3 having the third wavelength spectrum onto different points on the projection plane PP.

In the present embodiment, the illumination optical element 24 is a set lens including a plurality of lenses. However, in FIG. 6, for convenience, the set lens is schematically drawn by one lens.

The light flux emitted from the projection portion 22 passes through an illumination focal plane region FP1A of the illumination optical element 24 and passes through the illumination optical element 24, and an object face OS is irradiated with the light flux. A divergence angle of a light flux immediately after passing through an illumination focal plane FP1 is defined as a first divergence angle α1, and a divergence angle of a light flux immediately before entering the illumination focal plane FP1 is defined as a second divergence angle α2. However, the light flux from the projection portion 22 may be a converging light flux. In this case, the second divergence angle α2 is set to 0.

The light diffusion plate 28 is disposed on the illumination focal plane FP1 or illumination focal plane region FP1A. It is assumed that the light diffusion plate 28 is not a virtual one such as a projection image but is an entity. The light diffusion plate 28 increases the divergence angle of the light flux when the light flux passes through the focal plane FP1 or the focal plane region FP1A. That is, the divergence angle of the light passing through the light diffusion plate 28 is larger than the divergence angle before passing. In FIG. 10, for convenience, the virtual projection image PI is arranged on the illumination focal plane FP1, and the light diffusion plate 28 is arranged at a position adjacent to the downstream side of the virtual projection image PI. For example, it is also preferable to arrange the virtual projection image PI and to arrange the light diffusion plate 28 on the illumination focal plane FP1.

Next, an operation of the optical inspection apparatus 10 according to the present embodiment will be described.

The processing device 14 emits light from the light source 32 of the projection portion 22. The light flux emitted from the projection portion 22 forms the projection image PI on the projection plane PP. The position of the projection plane PP determined by the projection portion 22 is arranged in the focal plane region FP1A of the illumination optical element 24.

In the cross section of FIG. 6, the virtual projection image PI includes a first virtual region PIA1, a second virtual region PIA2, and a third virtual region PIA3. The first virtual region PIA1 is formed by imaging a light flux in which the first light beam L1 having the first wavelength spectrum is a main light beam on the projection plane PP. Further, the second virtual region PIA2 is formed by imaging a light flux in which the second light beam L2 having the second wavelength spectrum is a main light beam on the projection plane. Further, the third virtual region PIA3 is formed by imaging a light flux in which the third light beam L3 having a third wavelength spectrum is a main light beam on the projection plane PP. The first virtual region PIA1 crosses the optical axis C1. In FIG. 10, the virtual projection image PI is concentric with the optical axis C1. At this time, the first virtual region PIA1 and the third virtual region PIA3 are symmetrical with respect to the optical axis C2. However, the virtual projection image PI is not limited thereto, and may be any image.

The divergence angle α1 of the light flux immediately after passing through the illumination focal plane region FP1A becomes larger than the divergence angle α2 of the light flux immediately before the illumination focal plane region FP1A. One reason for this is that the projection portion 22 forms the projection image PI in the focal plane region FP1A. That is, the first divergence angle α1 is larger than the second divergence angle α2. Accordingly, the light flux reaching the illumination optical element 24 can reach not a local region of the illumination optical element 24 but a wider region. Thus, in a case where the optical apparatus 12 according to the present embodiment is used, there is an effect that an irradiation field in irradiation from the illumination optical element 24 to the object face OS is wide.

Further, in the present embodiment, the light diffusion plate 28 is disposed in the illumination focal plane region FP1A. Accordingly, the divergence angle of the light passing through the focal plane region FP1A can be further increased as compared with the case where the focal plane region FP1A is not arranged. That is, the light flux reaching the illumination optical element 24 can reach not a local region of the illumination optical element 24 but a wider region. Thus, there is an effect that the irradiation field in irradiation from the illumination optical element 24 to the object face OS is wider.

The illumination optical element 24 irradiates the object face OS with light incident through any point of the illumination focal plane FP1. Here, based on the geometric optics (see H. Ohno, “One-shot three-dimensional measurement method with the color mapping of light direction,” OSA Continuum, Vol. 4, Issue 3, 2021), an angle of a light beam passing through the illumination optical element 24 with respect to the optical axis C1 of the illumination optical element 24 is determined according to a passing point on the illumination focal plane FP1. That is, all the light beams emitted from the same passing point on the projection plane PP or the illumination focal plane FP1 have the same light beam angle by the illumination optical element 24. Accordingly, when a light flux in which the first light beam L1 is a main light beam is imaged on the projection plane PP, all the light beams included in the light flux become parallel light fluxes having the same light beam angle by the illumination optical element 24, and the object face OS is irradiated with the parallel light fluxes. Thus, the angle of the first light beam L1 with respect to the optical axis C1 becomes a first light beam angle β1, and the first light beam L1 is incident on the object face OS. Similarly, when a light flux in which the second light beam L2 is a main light beam is imaged on the projection plane PP, all the light beams included in the light flux become parallel light fluxes having the same light beam angle by the illumination optical element 24, and the object face is irradiated with the parallel light fluxes. When a light flux in which the third light beam L3 is a main light beam is imaged on the projection plane PP, all the light beams included in the light flux become parallel light fluxes having the same light beam angle by the illumination optical element 24, and the object face OS is irradiated with the parallel light fluxes. Accordingly, the angles of the second light beam L2 and the third light beam L3 with respect to the optical axis C1 become a second light beam angle β2, and the second light beam L2 and the third light beam L3 are incident on the object face OS.

The first divergence angle α1 is larger than the second divergence angle α2. On the other hand, when the first divergence angle α1 is gradually decreased, the number of points where the type of the light beam angle incident on the point decreases among the points on the irradiation field in irradiation from the illumination optical element 24 to the object face OS increases. In other words, by making the first divergence angle α1 larger than the second divergence angle α2, there is an effect that the type of the light beam angle incident on the point on the irradiation field in irradiation from the illumination optical element 24 to the object face OS can be increased. In particular, such an effect can be increased by the light diffusion plate 28.

Further, the light of the first wavelength spectrum and the light of the second wavelength spectrum have different colors. Thus, the optical apparatus 12 can irradiate the object face OS with a pencil of light beams having different light beam angles for respective colors. That is, the optical apparatus 12 can irradiate the object face OS with light beams having different incident angles for respective colors.

The BRDF of the surface OS of the object varies depending on the incident angle of the incident light beam. That is, the amount of information related to the surface OS of the object is larger in the two BRDFs for two incident angles than in the BRDF for one incident angle. As the amount of information related to the BRDF increases, the state of the surface OS of the object can be estimated in detail (see the second embodiment (including the modification)). The optical apparatus 12 according to the present embodiment can variously change the virtual projection image PI, thereby instantaneously changing the incident angle with respect to the surface OS of the object. Then, as described in the second embodiment (including the modification), there is an effect that a more detailed surface state of the object can be acquired by observing the reflected light by, for example, the imaging portion 26 each time.

Furthermore, in a case where projection images PI of different colors are projected to one virtual region PIA1 and two virtual regions PIA2 and PIA3 by appropriately partitioning the projection image PI into projection planes PI, and light beams having different incident angles for respective colors are incident on the surface OS of the object, the imaging portion 26 described in the second embodiment (including the modification) can distinguish the reflected light corresponding to the respective incident angles by color and simultaneously acquire the reflected light. That is, the optical apparatus 12 according to the present embodiment can make the light beams of at least two different wavelength spectra into light beams of different incident angles. Thus, for example, there is an effect that the imaging portion 26 can distinguish the reflected light corresponding to each of the incident angles by color and simultaneously acquire the reflected light. Accordingly, for example, there is an effect that the imaging portion 26 can acquire more detailed BRDF information. In particular, this contributes to improvement of inspection accuracy of the surface OS of the object in the optical inspection.

In the optical inspection, it is necessary to select an optimum direction of the light beam with which the surface OS of the object is irradiated according to various types of the object O. Thus, conventionally, for example, it is necessary to prepare various types of ring illumination (oblique incident illumination). However, in a case where the optical apparatus (illumination apparatus) 12 according to the present embodiment is used, there is an effect that the incident angle of the light beam can be changed by instantaneously changing the virtual projection image PI. That is, by using one optical apparatus 12 according to the present embodiment, it is possible to selectively achieve various kinds of illumination in various sizes without preparing a plurality of conventional illumination apparatuses.

From the above, the optical apparatus 12 of the optical inspection apparatus 10 according to the present embodiment can associate the direction of the light beam (the direction of the light flux) with the wavelength spectrum. The wavelength spectrum can be considered synonymous with a color of the light beam. Accordingly, it can be said that the direction of the light beam and the color of the light beam can be associated with each other. Further, the virtual projection image PI can be instantaneously changed by the projection portion 22. Thus, there is an effect that the optical apparatus 12 according to the present embodiment can instantaneously change the association between the direction of the light beam and a color of the light beam according to various uses.

### (Modification 1)

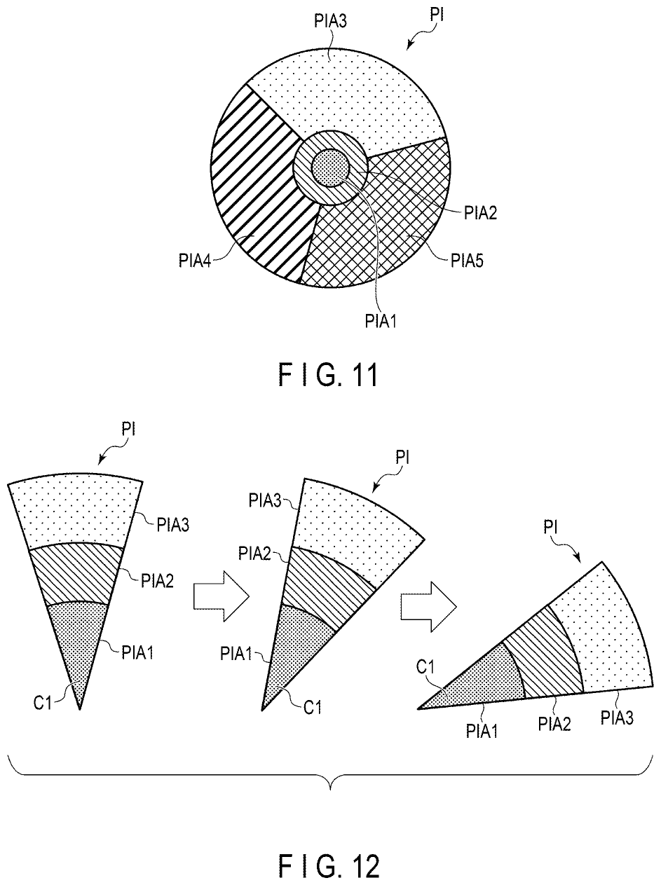

A first modification of the third embodiment will be described with reference to FIG. 11.

In the first modification of the present embodiment illustrated in FIG. 11, a virtual projection image PI is illustrated. The virtual projection image PI illustrated in FIG. 11 is orthogonal to the optical axis C1. In the present modification, a first wavelength spectrum and a second wavelength spectrum are the same as those described in the third embodiment. On the other hand, a third wavelength spectrum, a fourth wavelength spectrum, and a fifth wavelength spectrum are all different. For example, a peak of the third wavelength spectrum is 550 nm, and peaks of the fourth wavelength spectrum and the fifth wavelength spectrum are set to 500 nm and 600 nm, respectively. Full widths at half maximum of these wavelength spectra are 100 nm. It is assumed that the light source 32 of the projection portion 22 includes five light sources that emit light of these five wavelength spectra. Further, the projection portion 22 includes five spatial modulators 34 corresponding to the five light sources 32. These five types of light are multiplexed using a dichroic mirror or the like immediately before entering the projection lens 36.

In the present modification, as the virtual projection image PI, the center is concentric and the outside is rotationally symmetric by 120°. In other words, it is assumed that the center of the virtual projection image PI is axially symmetric and the outside of the virtual projection image PI changes in an azimuth angle direction. In the virtual projection image PI, a center portion of concentric circles is configured by a first wavelength selection region PI1 and a second wavelength selection region PI2 outside the first wavelength selection region PI1. In the virtual projection image PI, a third wavelength selection region PI3, a fourth wavelength selection region PI4, and a fifth wavelength selection region PI5 constitute an outer 120° rotationally symmetric region. Note that, in the virtual projection image PI, the first wavelength selection region PI1 crosses the optical axis C1 of the illumination optical element 24.

Note that, in the virtual projection image PI, there is a virtual black frame between adjacent regions. The virtual black frame is formed, for example, by not projecting light on the projection plane PP. Such a black frame can be virtually formed. Alternatively, the black frame may be actually formed by a shielding object instead of being virtual.

By using such a virtual projection image PI, there is an effect that the optical apparatus 12 of the optical inspection apparatus 10 according to the present modification not only can associate an angle of a light beam with respect to the optical axis C1 and a color of the light beam as an incident direction of the light beam on the object face OS, but also can associate an azimuth angle direction of the light beam with the color of the light beam. Accordingly, by observing a reflected light from the object surface OS while distinguishing the reflected light by color using the optical inspection apparatus 10 according to the present modification, there is an effect that the optical inspection apparatus 10 can simultaneously acquire detailed BRDF information regarding not only the angle of the light beam with respect to the optical axis C1 but also the azimuth angle. Thus, there is an effect that accuracy and speed of inspection for the presence or absence of a defect of the object face OS are improved by using the optical inspection apparatus 10 according to the present modification.

### (Modification 2)

A second modification of the third embodiment will be described with reference to FIG. 12.

In the second modification of the present embodiment illustrated in FIG. 12, a virtual projection image PI is illustrated. The virtual projection image PI illustrated in FIG. 12 is orthogonal to the optical axis C1. In the present modification, a first wavelength spectrum and a second wavelength spectrum are the same as those described in the third embodiment. On the other hand, the third spectrum is different from the third spectrum. For example, a peak of the third wavelength spectrum is 550 nm, and a full width at half maximum of the wavelength spectrum is 100 nm. It is assumed that the light source 32 of the projection portion 22 includes three light sources that emit light of these three wavelength spectra. Further, the projection portion 22 includes three spatial modulators 34 corresponding to the three light sources 32. These three types of light are multiplexed using a dichroic mirror or the like immediately before entering the projection lens 36.

In the present modification, the virtual projection image PI includes a fan-shaped first virtual region PIA1, a fan-shaped second virtual region PIA2, and a fan-shaped third virtual region PIA3. Then, under the control of the processing device 14, for example, the projection portion 22 changes an inclination of the virtual projection image PI on the projection plane PP while holding the same shape and the same size as illustrated from left to right in FIG. 12 in time series. Note that, for example, the first virtual region PIA1 crosses the optical axis C1 of the illumination optical element 24. The virtual projection image PI is in the same state as the virtual projection image PI rotated about the axis of the optical axis C1. The optical axis C1 may be at a fan-shaped vertex of the virtual projection image PI.

By using the virtual projection image PI by changing the virtual projection image PI in time series in this manner, there is an effect that the optical apparatus 12 not only can associate an angle of a light beam (direction of the light beam) with respect to the optical axis C1 and a color of the light beam as an incident direction of the light beam on the object face OS, but also can change an azimuth angle direction of the light beam in time series. Accordingly, by the imaging portion 26 observing a reflected light from the object surface OS while distinguishing the reflected light by color, there is an effect that the imaging portion 26 can simultaneously acquire BRDF information for different incident angles. Thus, there is an effect that accuracy and speed of inspection for the presence or absence of a defect of the object face OS are improved by using the optical inspection apparatus 10 according to the present modification. Further, the optical apparatus 12 can cause incident light having different incident azimuth angles to enter the object surface OS by changing the azimuth angle direction of the virtual projection image PI in time series. Thus, there is an effect that BRDF information for different incident azimuths can be acquired. That is, more detailed BRDF information can be acquired. Accordingly, there is an effect that the accuracy of the inspection for the presence or absence of a defect of the object face OS is improved by using the optical inspection apparatus 10 according to the present modification.

### Fourth Embodiment

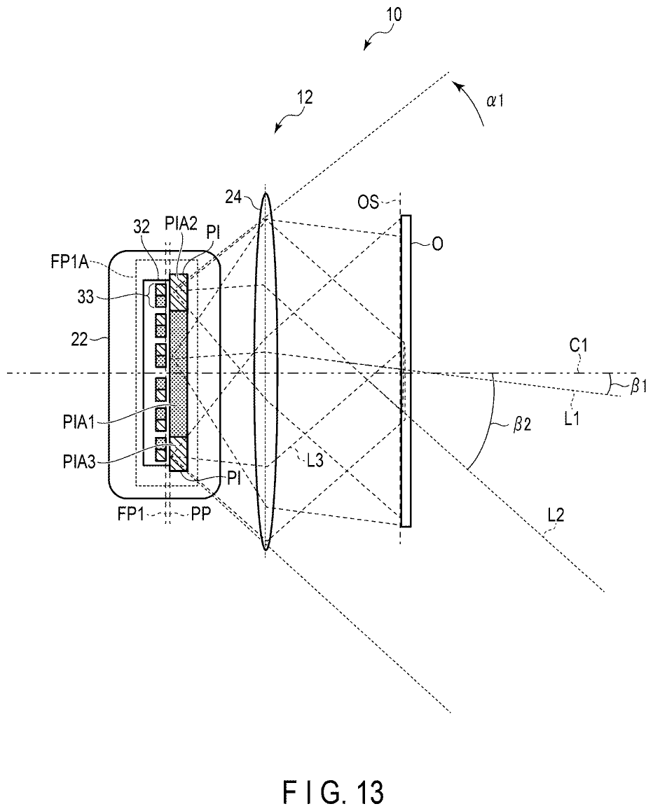

FIG. 13 is a schematic cross-sectional view of an optical apparatus 12 of an optical inspection apparatus 10 according to a fourth embodiment and a virtual projection image PI formed by the optical apparatus 12. The present embodiment is a modification of the optical inspection apparatus 10 described in the first embodiment including the modification, the second embodiment including the modification, and the third embodiment including the modification, and the same members or members having the same functions as the members described in the first embodiment including the modification, the second embodiment including the modification, and the third embodiment including the modification are denoted by the same reference numerals, and the description thereof will be omitted.

The optical apparatus 12 according to the present embodiment includes a projection portion 22 and an illumination optical element 24. The projection portion 22 is configured to instantaneously change (vary) the virtual projection image PI. In the present embodiment, a light source 32 of the projection portion 22 uses a light-emitting unit 33 including a plurality of Light-Emitting Diodes (LEDs) being configured to electrically and instantaneously switch between light emission of a first wavelength (for example, blue light) and light emission of a second wavelength (for example, red light). However, the light source 32 is not limited thereto, and various light sources can be used.

The light source 32 of the projection portion 22 includes a plurality of LED light-emitting units 33. Each light-emitting unit 33 can simultaneously or selectively emit light of two different wavelength spectra. These two different wavelength spectra are referred to as a first wavelength spectrum and a second wavelength spectrum, respectively. For example, the first wavelength spectrum is blue light having a peak at a wavelength of 450 nm and a full width at half maximum of 100 nm. Further, the second wavelength spectrum is red light having a peak at a wavelength of 650 nm and a full width at half maximum of 100 nm.

In the present embodiment, the illumination optical element 24 is a set lens including a plurality of lenses. However, in FIG. 13, for convenience, the set lens is schematically drawn by one lens.

A light emitting surface of the light source 32 is arranged in an illumination focal plane FP1 or an illumination focal plane region FP1A of the illumination optical element 24. In the present embodiment, the projection plane PP coincides with the light emitting surface of the light source 32.

A light flux emitted from the projection portion 22 immediately passes through the illumination focal plane region FP1A of the illumination optical element 24 and passes through the illumination optical element 24, and an object face OS is irradiated with the light flux. A divergence angle of a light flux immediately after passing through the illumination focal plane FP1 is defined as a first divergence angle α1, and a divergence angle of a light flux before entering the illumination focal plane FP1 is defined as a second divergence angle α2. However, here, since the light emitting surface of the light source 32 is arranged in the illumination focal plane FP1, there is no light flux before entering the illumination focal plane FP1. Thus, the second divergence angle α2 is set to 0.

Next, an operation of the optical inspection apparatus 10 according to the present embodiment will be described.

The light flux emitted from the projection portion 22 forms a projection image PI on the projection plane PP. The position of the projection plane PP determined by the projection portion 22 is arranged in the focal plane region FP1A of the illumination optical element 24.

In the cross section of FIG. 13, the projection image PI includes a first virtual region PIA1, a second virtual region PIA2, and a third virtual region PIA3. In FIG. 13, the projection image PI is concentric with the optical axis C1. At this time, the first virtual region PIA1 and the third virtual region PIA3 are symmetric with respect to the optical axis C1.

The divergence angle α1 of the light flux immediately after passing through the focal plane region FP1A becomes larger than the divergence angle α2 (not illustrated in FIG. 13, see FIGS. 1, 7, and 10) of the light flux immediately before the focal plane region FP1A. Accordingly, the light flux reaching the illumination optical element 24 can reach not a local region of the illumination optical element 24 but a wider region. Thus, in a case where the optical apparatus 12 according to the present embodiment is used, there is an effect that an irradiation field in irradiation from the illumination optical element 24 to the object face OS is wide.

The illumination optical element 24 irradiates the object face OS with light incident through any point of the illumination focal plane FP1. Here, based on the geometric optics (see H. Ohno, “One-shot three-dimensional measurement method with the color mapping of light direction,” OSA Continuum, Vol. 4, Issue 3, 2021), an angle of a light beam passing through the illumination optical element 24 with respect to the optical axis C1 of the illumination optical element 24 is determined according to a passing point on the illumination focal plane FP1. That is, all the light beams emitted from the same passing point on the projection plane PP or the illumination focal plane FP1 have the same light beam angle by the illumination optical element 24. Accordingly, when a light flux in which a first light beam L1 is a main light beam is imaged on the projection plane PP, all the light beams included in the light flux become parallel light fluxes having the same light beam angle by the illumination optical element 24, and the object face OS is irradiated with the parallel light fluxes. Thus, the angle of the first light beam L1 with respect to the optical axis C1 becomes a first light beam angle β1, and the first light beam L1 is incident on the object face OS. Similarly, when a light flux in which a second light beam L2 is a main light beam is imaged on the projection plane PP, all the light beams included in the light flux become parallel light fluxes having the same light beam angle by the illumination optical element 24, and the object face OS is irradiated with the parallel light fluxes. When a light flux in which the third light beam L3 is a main light beam is imaged on the projection plane PP, all the light beams included in the light flux become parallel light fluxes having the same light beam angle by the illumination optical element 24, and the object face OS is irradiated with the parallel light fluxes. Accordingly, the angles of the second light beam L2 and the third light beam L3 with respect to the optical axis C1 become a second light beam angle β2, and the second light beam L2 and the third light beam L3 are incident on the object face OS.

The BRDF of the surface OS of an object varies depending on the incident angle of an incident light beam. That is, the amount of information related to the surface OS of the object is larger in the two BRDFs for two incident angles than in the BRDF for one incident angle. As the amount of information related to the BRDF increases, the state of the surface OS of the object can be estimated in detail (see the second embodiment (including the modification)). Thus, the projection image PI can be variously changed by the optical apparatus 12 according to the present embodiment, thereby instantaneously changing the incident angle of the object with respect to the surface OS. Then, as described in the second embodiment (including the modification), there is an effect that a more detailed surface state of the object can be acquired by observing the reflected light by, for example, the imaging portion 26 each time.

Furthermore, for example, in a case where the imaging portion 26 projects projection images PI of different colors to one virtual region PIA1 and two virtual regions PIA2 and PIA3 by appropriately partitioning the projection image PI into projection planes PI, and light beams having different incident angles for respective colors are incident on the surface OS of the object, the imaging portion 26 described in the second embodiment (including the modification) can distinguish the reflected light corresponding to the respective incident angles by color and simultaneously acquire the reflected light. That is, the optical apparatus 12 according to the present embodiment can make the light beams of at least two different wavelength spectra into light beams of different incident angles. Thus, for example, there is an effect that the imaging portion 26 can distinguish the reflected light corresponding to each of the incident angles by color and simultaneously acquire the reflected light. Accordingly, for example, there is an effect that the imaging portion 26 can acquire more detailed BRDF information. In particular, this contributes to improvement of inspection accuracy of the surface OS of the object in the optical inspection.

In the optical inspection, it is necessary to select an optimum direction of the light beam with which the surface OS of the object is irradiated according to various types of the object O. Thus, conventionally, for example, it is necessary to prepare various types of ring illumination (oblique incident illumination). However, in a case where the optical apparatus (illumination apparatus) 12 according to the present embodiment is used, there is an effect that the incident angle of the light beam can be changed by instantaneously changing the projection image PI. That is, by using one optical apparatus 12 according to the present embodiment, it is possible to selectively use various kinds of illumination in various sizes without preparing a plurality of conventional illumination apparatuses.

From the above, the optical apparatus 12 of the optical inspection apparatus 10 according to the present embodiment can associate the direction of the light beam with the wavelength spectrum. The wavelength spectrum can be considered synonymous with a color of the light beam. Thus, it can be said that the direction of the light beam can be associated with the color. Further, the projection portion 22 can instantaneously change the projection image PI. Thus, the optical apparatus 12 according to the present embodiment has an effect that the association between the direction of the light beam and the color can be instantaneously changed according to various uses.

### Modification

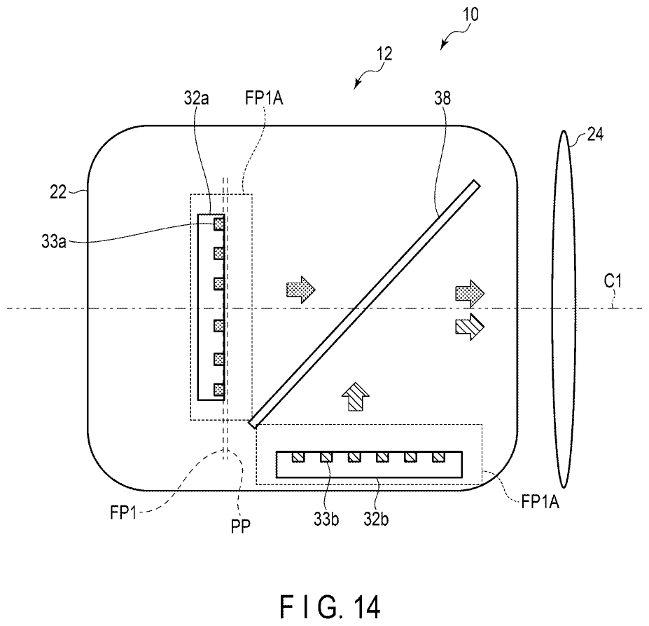

FIG. 14 is a schematic cross-sectional view of an optical apparatus 12 of an optical inspection apparatus 10 according to a modification of the fourth embodiment.

The optical apparatus 12 according to the present modification illustrates a first light source 32a and a second light source 32b having different wavelength spectra as the light source 32. The first light source 32a includes a plurality of first light-emitting units 33a. The second light source 32b includes a plurality of second light-emitting units 33b. The first light-emitting units 33a simultaneously or selectively emit light of the first wavelength spectrum. Each of the second light-emitting units 33b emits light of the second wavelength spectrum. The light from the first light source 32a and the second light source 32b is multiplexed by the dichroic mirror 38. The dichroic mirror 38 may be a polarizing beam splitter or a non-polarizing beam splitter. The dichroic mirror 38 is not limited to this, and may be anything as long as it can combine two light beams. In a case where a polarization beam splitter is used as the dichroic mirror 38, if a polarization camera being configured to sense a polarization direction is used as the imaging element 56 of the imaging portion 26, it is possible to acquire a large amount of information related to a direction distribution of light at an object point by similarly using polarization information as well as color information. By using the two light sources 32a and 32b, it is possible to newly generate a wavelength spectrum having two separated peaks after multiplexing. Thus, for example, the first wavelength spectrum and the second wavelength spectrum can be greatly different from each other, and it is possible to accurately distinguish colors and more accurately and quickly acquire the information related to the direction distribution of light. Alternatively, light intensities of the two light sources 32a and 32b can be appropriately adjusted independently.

From the above, the optical apparatus 12 of the optical inspection apparatus 10 according to the present modification can associate the direction of the light beam with the wavelength spectrum. Further, the projection portion 22 can instantaneously change the projection image PI. Thus, the optical apparatus 12 according to the present modification has an effect that the association between the direction of the light beam and the color can be instantaneously changed according to various uses.

### Fifth Embodiment

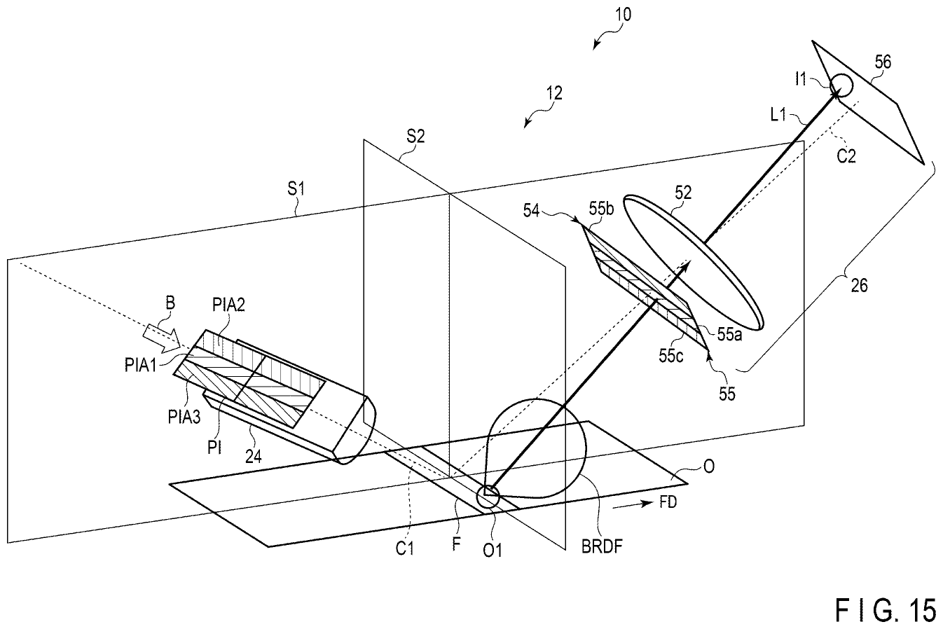

Hereinafter, an optical apparatus 12 according to a fifth embodiment will be described with reference to FIG. 15.

FIG. 15 is a schematic perspective view of the optical apparatus 12 of an optical inspection apparatus 10 according to the present embodiment and a virtual projection image PI formed by the optical apparatus 12. The optical apparatus 12 according to the present embodiment includes a projection portion 22, an illumination optical element 24, and an imaging portion 26. However, in FIG. 15, illustration of the projection portion 22 of the optical apparatus 12 is omitted. As the projection portion 22, various projectors described in the first to fourth embodiments can be used. The basic configuration of the optical apparatus 12 is the same as that of the optical apparatus 12 described in the first to fourth embodiments. Differences will be described below.

A first cross section S1 in FIG. 15 includes an illumination optical axis C1 and an imaging optical axis C2. A second cross section S2 is orthogonal to the first cross section S1.

The illumination optical element 24 has translational symmetry in a direction orthogonal to the first cross section S1. This direction is defined as a longitudinal direction of the illumination optical element 24. The illumination optical element 24 is, for example, a cylindrical lens. The illumination optical axis C1 of the cylindrical lens is on the first cross section S1.

The projection portion 22 uses a light flux B from a light source 32 to project the virtual projection image PI onto a focal plane region FP1A of the illumination optical element 24. For example, it is assumed that the virtual projection image PI includes a first virtual region PIA1, a second virtual region PIA2, and a first virtual region PIA3. On the virtual projection image PI, a direction along a direction in which the virtual projection image PI changes is set as an arrangement direction. This arrangement direction is parallel to the first cross section S1. That is, the arrangement direction of the virtual projection image PI is orthogonal to the longitudinal direction of a line sensor 56. Then, it is assumed that the first virtual region PIA1 crosses the optical axis C1. Accordingly, the object surface OS is illuminated, and an irradiation field F is formed. In a case where this illumination light is projected on the second cross section S2, it becomes divergent light. However, it is not limited thereto, and the virtual projection image PI may be any image that changes in any manner.

Note that, while the projection image PI by the light flux B from the projection portion 22 can be instantaneously changed, as an example, light of a first wavelength projected in the first virtual region PIA1 is shielded by a first wavelength selection region 55a of a wavelength selection portion 55 to be described later, and passes through a second wavelength selection region 55b and a third wavelength selection region 55c. Light of a second wavelength projected in the second virtual region PIA2 passes through the first wavelength selection region 55a of the wavelength selection portion 55 to be described later, is shielded by the second wavelength selection region 55b, and passes through the third wavelength selection region 55c. Light of a third wavelength projected in the third virtual region PIA3 passes through the first wavelength selection region 55a and the second wavelength selection region 55b of the wavelength selection portion 55 to be described later, and is shielded by the third wavelength selection region 55c.

The imaging portion 26 includes an imaging optical element 52, an imaging opening 54, and an imaging element 56. The optical axis C2 of the imaging optical element 52 intersects the wavelength selection portion 55 to be described later of the imaging opening 54. The imaging element 56 is an image sensor, and is a line sensor in the present embodiment. The longitudinal direction of the line sensor 56 coincides with the longitudinal direction of the illumination optical element 24.

The imaging opening 54 includes the wavelength selection portion 55 instead of the through hole 54a described in the first embodiment (FIG. 7). In FIG. 15, illustration of the medium 54b of the imaging opening 54 is omitted. In the present embodiment, the through hole 54a is preferably formed in a rectangular shape elongated in the longitudinal direction of the line sensor 56. The wavelength selection portion 55 of the imaging opening 54 has translational symmetry in a direction orthogonal to the first cross section S1. This direction is defined as a longitudinal direction of the wavelength selection portion 55. The wavelength selection portion 55 includes the regions 55a, 55b, and 55c arranged in a stripe shape. On the wavelength selection portion 55, a direction along a direction in which the wavelength selection portion 55 changes is set as an arrangement direction. This arrangement direction is parallel to the first cross section S1. That is, the arrangement direction of the wavelength selection portion 55 is orthogonal to the longitudinal direction of the line sensor 56.

Note that, around the imaging opening 54, similarly to the imaging opening 54 described in the first embodiment (FIG. 7), the outside of the wavelength selection portion 55 is preferably formed as a light shielding portion for the line sensor 56 as the medium 54b.

The object O is conveyed in a direction indicated by an arrow FD orthogonal to the longitudinal direction of the line sensor 56. The line sensor 56 can acquire a two-dimensional image by continuously imaging the object O conveyed in this manner.

The light flux emitted from the projection portion 22 (see the first to fourth embodiments) passes through the virtual projection image (illumination-side wavelength selection portion) PI and irradiates the object surface OS, thereby forming the irradiation field F on the object surface OS.

In a case where there is a minute defect at the first object point O1 on the object surface OS, the BRDF spreads, and some light beams selectively pass through the regions 55a, 55b, and 55c of the wavelength selection portion 55 of the imaging opening 54 to image the first object point O1 on the line sensor 56.

On the other hand, in a case where the first object point O1 is on the standard surface, the first light beam L1 having the first wavelength is specularly reflected on the standard surface. At this time, by appropriately forming the virtual projection image PI, the first light beam L1 can reach the center of the imaging opening 54 of the imaging portion 26. That is, the first light beam L1 can reach the region including the imaging optical axis C2. The first wavelength selection region 55a of the wavelength selection portion 55 arranged at the center of the imaging opening 54 is formed to shield light of the first wavelength. Accordingly, in a case where the minute defect does not exist at the first object point O1, the first object point O1 is not imaged with the light of the first wavelength. On the other hand, in a case where the minute defect exists at the first object point O1, the first object point O1 is imaged with the light of the first wavelength. Thus, there is an effect that the presence or absence of the minute defect can be identified using the optical inspection apparatus 10 according to the present embodiment. Further, by using the optical inspection apparatus 10 according to the present embodiment, information related to the spread of a direction distribution of light (that is, BRDF) at the object point can be obtained.

Further, in a case where the first object point O1 is on the standard surface, the second light beam L2 having the second wavelength different from the first wavelength is also specularly reflected on the standard surface similarly. The first wavelength selection region 55b of the wavelength selection portion 55 arranged at the center of the imaging opening 54 is formed to shield the light of the second wavelength. Accordingly, in a case where the minute defect does not exist at the first object point O1, the first object point O1 is not imaged with the light of the second wavelength. On the other hand, in a case where the minute defect exists at the first object point O1, the first object point O1 is imaged with the light of the second wavelength. However, even in a case where the first object point O1 is on the standard surface, the virtual projection image PI is instantaneously changed by the projection portion 22, and the virtual projection image PI is appropriately formed, so that the reflection direction of the second light beam L2 can be matched with the imaging optical axis C2. Thus, the light beam of the second wavelength reaches the center of the imaging opening 54 of the imaging portion 26. That is, it reaches a region including the imaging optical axis C2 on the imaging opening 54. The first wavelength selection region 55a of the wavelength selection portion 55 arranged at the center of the imaging opening 54 transmits the light of the second wavelength and is formed to be imaged by the line sensor 56. At this time, based on the geometric optics, the imaging portion 26 has telecentricity on the object side with respect to the second wavelength. That is, the optical apparatus 12 according to the present embodiment has the object side telecentricity for light having at least one wavelength in the light from the light source 32. Thus, the optical apparatus 12 of the optical inspection apparatus 10 according to the present embodiment has an effect that a bright field telecentric image can be acquired by the second wavelength. That is, the optical apparatus 12 of the optical inspection apparatus 10 according to the present embodiment can acquire detailed information of the object surface together with the captured image using the first light beam.

Note that, similarly to the second wavelength, in a case where the first object point O1 is on the standard surface, the third wavelength is specularly reflected on the standard surface. The first wavelength selection region 55c of the wavelength selection portion 55 arranged at the center of the imaging opening 54 is formed to shield the light of the third wavelength. Accordingly, in a case where the minute defect does not exist at the first object point O1, the first object point O1 is not imaged with the light of the third wavelength. On the other hand, in a case where the minute defect exists at the first object point O1, the first object point O1 is imaged with the light of the third wavelength. However, even in a case where the first object point O1 is on the standard surface, the projection portion 22 instantaneously changes the virtual projection image PI to appropriately form the virtual projection image PI, so that the third light beam is transmitted through the first wavelength selection region 55a and captured by the line sensor 56. At this time, based on the geometric optics, the imaging portion 26 has the telecentricity on the object side with respect to the third wavelength. That is, the optical apparatus 12 according to the present embodiment has the object side telecentricity for light having at least one wavelength in the light from the light source 32.

It is considered that a light beam is projected on the first cross section S1. At this time, as illustrated in FIG. 15, the distribution of the BRDF at the first object point O1 is widened, so that light that reaches and passes through the wavelength selection portion 55 that has not reached in the case of the standard surface occurs. Here, it can be seen that the reflected light reaches the different regions 55b and 55c of the wavelength selection portion 55 in the imaging opening 54 according to the direction of the reflected light. However, a light beam reaching outside the range of the imaging opening 54 is not imaged. That is, the range of the light beam direction that can be imaged is limited by the imaging opening 54.

On the other hand, it is considered that a light beam is projected on the second cross section S2. At this time, since light from the projection portion 22 is diffused light, it can be seen that the angle of view in the imaging portion 26 becomes wider according to the divergence angle of the diffused light. Then, since the wavelength selection portion 55 has a stripe shape, it can be seen that the color of the light beam does not depend on the angle of view. Further, by making the longitudinal direction of the stripe sufficiently long, there is an effect that the angle of view in the longitudinal direction of the line sensor 56 can be widely and effectively used. Furthermore, with the configuration in which the wavelength selection portion 55 is arranged in front of the imaging optical element 52 and the imaging element 56, the present optical system can be easily combined with any combination of the imaging optical element 52 and the imaging element 56.

The optical inspection apparatus 10 according to the present embodiment can obtain information related to the spread of the direction distribution of light at the object point O1. Further, there is an effect that an imaging visual field of the optical apparatus 12 of the optical inspection apparatus 10 according to the present embodiment can be widened as the longitudinal direction of the line sensor 56 is lengthened. Thus, the optical inspection apparatus 10 according to the present embodiment can inspect the property or shape of the object surface OS.

From the above, the optical apparatus 12 of the optical inspection apparatus 10 according to the present embodiment can associate the direction of the light beam (the direction of the light flux) with the wavelength spectrum. Further, the virtual projection image PI can be instantaneously changed by the projection portion 22 of the optical apparatus 12. For example, in the projection plane PP, each of the regions PIA1, PIA2, and PIA3 can be expanded and contracted in an appropriate direction. Thus, there is an effect that the optical apparatus 12 according to the present embodiment can instantaneously change the association between the direction of the light beam and a color of the light beam according to various uses.

According to at least one of the embodiments described above, it is possible to provide the optical apparatus 12, the optical inspection apparatus 10, the optical inspection method, and the optical inspection program stored in a non-transitory storage medium such as a storage apparatus 64 that can associate the direction of the light beam (the direction of the light flux) with the wavelength spectrum.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical apparatus comprising:
an illumination optical element having a focal plane or a focal plane region including a vicinity of the focal plane; and
a projection portion including a light source,
wherein:
the projection portion is configured to emit a light flux including light of at least two different wavelength spectra from the light source to the illumination optical element, and
the projection portion is configured to form a projection image at different positions by light of the two different wavelength spectra in the focal plane or the focal plane region of the illumination optical element.

2. The optical apparatus according to claim 1, wherein the projection portion is configured to emit light fluxes including light of at least two different wavelength spectra in a same period from the light source.

3. The optical apparatus according to claim 1, wherein the projection portion is configured to change the projection image by the light of the two different wavelength spectra in time series.

4. The optical apparatus according to claim 1, wherein the projection portion makes a divergence angle immediately after the light flux from the light source passes through the focal plane or the focal plane region larger than a divergence angle immediately before the light flux passes through the focal plane or the focal plane region.

5. The optical apparatus according to claim 1, wherein the projection portion is configured to image the light flux from the light source on the focal plane or the focal plane region.

6. The optical apparatus according to claim 1, wherein:
a light emitting surface of the light source is disposed in the focal plane or the focal plane region, and
the light source is configured to independently emit light of the two different wavelength spectra in different regions.

7. The optical apparatus according to claim 1, further comprising a light diffusion portion which increases a divergence angle of the light flux when the light flux passes through the focal plane or the focal plane region.

8. The optical apparatus according to claim 1, further comprising an imaging portion which is configured to disperse at least two different wavelengths included in the light of the at least two different wavelength spectra, respectively, in the light from the light source.

9. The optical apparatus according to claim 1, further comprising an imaging portion which has object side telecentricity for light having at least one wavelength in the light from the light source.

10. The optical apparatus according to claim 1, wherein the illumination optical element has a lens.

11. An optical inspection apparatus comprising:
the optical apparatus according to claim 9; and
a processor that is configured to control the imaging portion, causes the imaging portion to acquire an image, and performs optical inspection of an object surface based on information of color of the image captured by the imaging portion.

12. The optical inspection apparatus according to claim 11, wherein the processor is configured to output a state of the object surface based on a number of colors emitted from the light source and a number of colors acquired in respective pixels of the imaging portion when the optical inspection is performed.

13. An optical inspection method using the optical apparatus according to claim 9, the optical inspection method comprising:
acquiring an image of an object surface by the imaging portion; and
performing an optical inspection based on information of color of the image captured by the imaging portion.

14. The optical inspection method according to claim 13, wherein the performing the optical inspection includes outputting a state of the object surface based on a number of colors emitted from the light source and a number of colors acquired in respective pixels of the imaging portion.

15. A non-transitory storage medium storing an optical inspection program using the optical apparatus according to claim 9, the program causing a computer to perform:
acquiring an image of a surface of an object by the imaging portion; and
performing an optical inspection of the surface of the object based on information of color of the image captured by the imaging portion.

16. The non-transitory storage medium according to claim 15, wherein the performing the optical inspection includes causing the computer to perform outputting a state of the surface of the object based on a number of colors emitted from the light source and a number of colors acquired in respective pixels of the imaging portion.
